(19) United States
(12) Patent Application Publication
(10) Pub. No.: US 2023/0351711 A1
(43) Pub. Date: Nov. 2, 2023

(54) Augmented Reality Platform Systems, Methods, and Apparatus

(71) Applicant: lifecache LLC, Homestead, FL (US)

(72) Inventors: Khambrel Roach, Homestead, FL (US); Sean Fenton, Pembroke Pines, FL (US)

(73) Assignee: lifecache LLC, Homestead, FL (US)

(21) Appl. No.: 18/309,799

(22) Filed: Apr. 29, 2023

Related U.S. Application Data
(60) Provisional application No. 63/336,829, filed on Apr. 29, 2022.

(51) Int. Cl. G06T 19/00

(52) U.S. Cl. CPC G06T 19/006

(57) ABSTRACT

Systems, methods, and apparatus are disclosed involving an augmented reality (AR) platform. An exemplary system includes a server and an apparatus, comprising a console, and possibly an auxiliary computing device. The console includes: a camera adapted to receive reality-based visual image input of targeted content and to generate reality-based video data thereof; and positioning sensors adapted to generate positioning data for determination of the position and orientation of the console. The console is adapted to communicate, directly or indirectly, video data and positioning data to the server and receive, directly or indirectly, from the server augmented-reality overlay data, which the server is adapted to generate based on the positioning data. The system is adapted to combine the AR-overlay data and the video data, to generate AR-overlaid video data, and to transmit the AR-overlaid video data to the console, which is adapted to display the AR-overlaid video data.

### CROSS REFERENCE TO RELATED APPLICATION

This application is related to, is the non-provisional of, and claims the benefit of U.S. Provisional Utility Patent Application Ser. No. 63/336,829 (“the '829 application”), titled “Augmented Reality Platform Systems, Methods, and Apparatus” and filed Apr. 29, 2022, each of which is incorporated by reference herein in its entirety for all purposes.

### BACKGROUND OF THE INVENTION

The invention relates to systems, methods and apparatus involving an augmented reality platform, and in a particular embodiment, to an entertainment, social, and educational system involving at least one console unit coupled to a media server that overlays augmented reality content to a video displayed on the console unit, wherein the augmented reality content is determined based in part on the position, location, orientation, and point of view of the console unit relative to viewable images of targeted content, as viewable from the position, location, orientation, and point of view of the console unit. Related areas of technology include augmented reality, virtual reality, mixed reality, 360-degree video/photo content, location-based services, and the metaverse.

The related art includes, for instance, tools, products, and systems to generate augmented reality (“AR) and virtual reality (“VR”). While VR typically immerses a user into a synthetic computer-generated (“CG”) world with no direct, non-CG views of reality, AR typically superimposes CG images and/or graphics over a real-world view, typically as viewed on a display through an associated camera, thus forming a composite image and allowing for combinations of visual information to be presented in real time. AR integrates the real world with the virtual content, thereby “augmenting” the quality of the user's visual experience. Prior-art AR implementations include smartphone game applications and retailers' applications enabling the “drag and drop” of a retailer's products in images of a customer's room, and while this technology is affordable, it is currently limited to smartphone applications (“apps”) of limited potential, performance, and capabilities.

Augmented Reality is widely seen as the next evolution of media experiences that will be a prominent technology this decade. Augmented Reality is still an emerging technology that has seen growing interest from major tech companies globally in recent years. Augmented Reality presently is in its infant stages as a technology and industry. The present invention foresees that Augmented Reality and location-based services will one day have a unique place in our lives.

Most AR experiences today involve overlaying the physical world with known, fixed information. Maps and games have garnered much attention in the consumer tech space. For example, a vehicle's navigation app typically displays CG depictions of relevant roads in an VR route to guide a driver, whereas the vehicle's backup camera may use CG guidelines overlaying the camera's video feed to create an AR guide to assist a driver in backing up the vehicle. Conversely, a “heads-up” display in a vehicle may project images, such as a vehicle's speed, onto the interior underside surface of the vehicle's windshield, to make the projected images visible to a driver of the vehicle looking through the windshield, thereby augmenting the reality of the driver's vision of the real world with views of the projected images. In the industrial world, the AR capabilities typically are centered around visualization, instruction, and guiding. Some examples include the following: virtual work instructions for operating manuals; service maintenance logs with timely imprinted digitized information; and remote guidance connecting company experts to junior level staff with live on-site annotations.

Several companies are attempting to complete consumer-friendly, affordable, and wearable AR devices and AR headsets that attempt to seamlessly blend the real world with current information and updates. Examples of this technology include in-car navigation systems and the use of pins for various home applications such as bathroom mirror weather apps, refrigerator door cooking apps, and bedroom wall pins. The underlying premise is that giving people the ability to automatically access relevant information works better when that information is integrated into a person's perception of the physical world. Other companies are seeking to build on, capitalize on, and expand VR technology, such as the social media company originally known as Facebook that rebranded itself as Meta in efforts to leverage the opportunities in the “metaverse” of VR environments.

Wearable AR glasses and VR devices, also known as Head Mounted Displays (HMDs), have received considerable attention and investigation due to their potential to harmonize human-to-computer interaction and enhance user performance of an activity performed by a user wearing the AR or VR device. The applications for HMDs span the fields of entertainment systems, education & training, interactive controls, three-dimensional (“3D”) visualizations, tele-manipulation, and wearable computers. HMDs and similar “wrap-around headsets” have been suitable for testing, but some HMDs are turning out to be impractical for wearing for longer periods of time. HMDs also can be expensive, be uncomfortable, and have short battery lives. Other drawbacks of HMDs include the use requirements that HMDs must be worn continuously on a user's head, HMDs affect a user's hairstyling, and HMDs continuously press against a user's face, scalp, and skull. Moreover, the ways data are captured, sent, and received by HMDs require more sensors, which further affect HMDs' size, weight, and cost. In addition, AR headsets typically have a limited field of view and do not create solid images for the user.

Besides work being done with HMDs, other developers currently are doing work with wearable glasses, contact lenses, and other lighter headsets. Because wearable glasses, and contact lenses typically involve a wearer looking through the glasses and lenses and seeing the reality visible therethrough, as with a heads-up display, such devices enable only AR experiences, and not VR experiences, inasmuch as VR involves the immersion of the user in an entirely-computer-generated visual experience (or at least a display displaying only VR content). AR wearable glasses are meant for daily use working in tandem with a smart phone app, with the app running on a smartphone acting as an auxiliary computing device working with the AR wearable glasses, and neither the pair of glasses, nor the device, nor the app is intended for high-end performance.

In contrast to the prior art, the present invention, including a commercially-available product embodiment of the present invention, marketed under the trademark Lifecache®, is unique in its design, in its functionality, and in its intended use of the present invention. The present invention is unlike prior art concepts that have approached AR technology from other angles. The prior art lacks a dedicated platform that serves and manages immersive media at scale for both consumers and businesses to easily leverage. In contrast, the Lifecache® solution seeks to pioneer the mass adoption of immersive media incorporating Augmented Reality, Virtual Reality, and 360-degree digital experiences.

Unlike other commercial prior art, the present invention incorporates 360-degree content and pioneers a new way for creators of 360-degree content to manage and scale their content to the masses. The Lifecache® platform provides the first centralized ecosystem of immersive content experiences for both consumer and enterprise users. The Lifecache® system aggregates immersive media in an ecosystem conducive to the consumer experience, in a manner that ties memories into a location-based journey for people to explore and engage with, and that is supported by an integrated backend portal that enables content management and synthesizes information and analytics derived from the unique front-end experience.

The Lifecache® application may be used with HMDs, AR glasses, smartphones, tablets, or laptop browser to provide a versatile, dynamic, and rich experience that is easy to use and provides a mixture of AR functionality and access controls.

As described below, embodiments of the present invention include the use of novel features within an augmented reality platform comprising an entertainment, social, and educational system involving console units running software adapted to customize and augment content presented at a venue, using systems and methods different from those of the prior art systems and methods.

### BRIEF SUMMARY OF THE INVENTION

The invention relates to systems, methods and apparatus involving an augmented reality platform, and in a particular exemplary embodiment, to an entertainment, social, and educational system including a server and an apparatus adapted for generating and displaying in real-time an augmented reality video stream based on a point of view of the apparatus relative to a targeted scene, backdrop, background, foreground, location, theme, business, and/or audience, in which computer-generated content is generated by a processor and then may be overlaid over a video feed of the target from a camera on the apparatus.

The Lifecache® platform provides the first centralized ecosystem of immersive content experiences for both consumer and enterprise users. A key feature of the Augmented Reality experience delivered by the Lifecache® system is the combination of 360-degree content experiences and traditional two-dimensional (“2D”) content experiences on a street level view, in which items of content exist all around in a user's field of view. The Lifecache® system may work, for example, with standard 2D-capture cameras on typical smartphones, with 2D-capture cameras on smartphone having features permitting capture of 360-degree content, and/or with special-purpose, independent 2D-capture, 3D-capture, 3D-enabled, 360-degree-capture, and/or 360-degree-enabled cameras capturing 2D, 3D, and/or 360-degree content that may be transferred to, communicated to, uploaded to, and/or accessed by a smartphone or other computing device, such as a tablet, laptop, or desktop computer, which may be networked to access the Lifecache® server and/or Lifecache® online portal. Popular separate cameras having rich features sets include models by GoPro®, Canon®, Panasonic®, and others, some of which have their own software and apps that may be used to process the content before the content is transferred to, communicated to, uploaded to, and/or accessed by a smartphone or other computing device running the Lifecache® app or communicating with the Lifecache® portal or server. Moreover, in some embodiments, a separate camera may be able to transfer, communicate, or upload the content directly to the Lifecache® server or portal.

In a standard embodiment, a use scenario may include a user using a camera integrated into a smartphone running the Lifecache® app and displaying content directly on a display integrated into the smartphone, in which the app is in communication with the Lifecache® server. In some embodiments, a use scenario may include a user using a separate 360-degree-enabled camera communicating with a smartphone running the Lifecache® app, and the app may be in communication with the Lifecache® server, the server acting as a remote computing device, in which case the separate camera and the smartphone might be considered a combination of a console and a separate local computing device, with features and functions distributed between them. In some embodiments, the user may use AR glasses or an HMD to view the content, and the pair of AR glasses or the HMD may be in communication with the smartphone running the Lifecache® app, such that the separate camera, the smartphone, and the pair of AR glasses or the HMD comprise a combination of a console and two separate local computing devices, with features and functions distributed between the components of the combination. In some embodiments, the user may use the pair of AR glasses or the HMD with the smartphone running the Lifecache® app, the smartphone may be in communication with a laptop or a desktop computer, which may have a high-speed data network connection, and the app may be in communication with the laptop or desktop computer, and the app and/or the laptop or desktop computer may be in communication with the Lifecache® server or portal, such that the separate camera, the smartphone, the pair of AR glasses or the HMD, and the laptop or desktop computer comprise a combination of a console and three separate local computing devices, with features and functions distributed between the components of the combination. Various embodiments of the present invention are envisioned and described.

The Lifecache® system provides a location-based experience in which users can capture, save, and share their electronically-captured, digital “memories” at the locations around the world for themselves and others to explore. Each Memory may be plotted on a map that may be adapted to show where memories exist at different regions of the world. The Memories Map also may contain searching and filtering functions to assist in isolating specific areas and memories users want to explore. The Lifecache® portal is a backend web portal that allows for content management and collects analytics for both users and marketers to leverage. The Lifecache® backend portal and frontend app are synched and work cohesively to form a platform allowing users to associate content with a geographical location, and to push content to users in such geographical location in real time. The Lifecache® headset experience may combine the features of the mobile experience with an enhanced feature set on the headset display to be leveraged on Mixed Reality headsets. Overall, the Lifecache® system may be an operating-system-agnostic software end-to-end solution that streamlines an immersive experience from, for example, the mobile device, to the web Portal, and to mixed reality headsets.

In accordance with a first aspect of the invention, a system is disclosed that is adapted for use in displaying computer-generated content, in which the system comprises software adapted to run on a server and an apparatus, or an assembly including an apparatus; in which the software on the apparatus is adapted to capture and process information and data on and from the apparatus, to manifest information and data on the apparatus, to communicate with the server, to send information and data to the server, to receive information and data from the server, to combine information and data from the apparatus and from the server, and to manifest the combined information and data on the apparatus; and in which the software on the server is adapted to communicate with the apparatus, to receive information and data from the apparatus, to send information and data to the apparatus, to process information and data on and from the apparatus, to combine information and data from the apparatus and from the server, and to send combined information and data to the apparatus; wherein the software is adapted to identify the apparatus, to identify a location and an orientation of the apparatus, to identify a point of view of the apparatus, to capture information and data relating to a user's “memory” experience or a moment of the apparatus (the moment's information and data based on the apparatus' identity, location, orientation, and point of view), to manifest on the apparatus the information and data relating to the “memory” or moment, to send to the server the information and data relating to the “memory” or moment, to receive from the server other information and data relating the “memory” or moment, to combine information and data relating to the “memory” or moment from the apparatus with other information and data relating to the “memory” or moment from the server, and to manifest on the apparatus the combined information and data relating to the “memory” or moment.

The server comprises: electronic circuitry and hardware including: a processor; a memory, the memory coupled to the processor; a data transfer module, the data transfer module coupled to the processor; a data transfer device, the data transfer device coupled to the processor; electronic software, the software stored in the electronic circuitry and hardware and adapted to enable, drive, and control the electronic circuitry and hardware; a power supply connection, the power supply connection coupled to the electronic circuitry and hardware and couplable to a power supply.

The assembly, including aspects of the apparatus, comprises: electronic circuitry and hardware including: a processor; a camera, the camera coupled to the processor; a display, the display coupled to the processor; a memory, the memory coupled to the processor; a positioning device, the positioning device coupled to the processor; a data transfer module, the data transfer module coupled to the processor; a data transfer device, the data transfer device coupled to the processor; electronic software, the software stored in the electronic circuitry and hardware and adapted to enable, drive, and control the electronic circuitry and hardware; a power supply connection, the power supply connection coupled to the electronic circuitry and hardware and couplable to a power supply; and a housing, the housing comprising an interior and an exterior housing, the interior containing the electronic circuitry and hardware, the software, and the power supply connection; and the exterior housing comprising a frame enclosing the interior. In some embodiments, the assembly and/or the apparatus may include a console or a headset having an optical lens assembly, the optical lens assembly adapted to magnify and to focus an image rendered and displayed on the display. The display may be transparent, as in a heads-up display, or non-transparent, as in a smartphone or an enclosed HMD.

The positioning device is adapted to generate positioning data indicative of at least one parameter of a group consisting of a position, a location, an orientation, a movement, and a point of view of the apparatus. The computer-generated content includes dynamic content changing over time and space in real-time as related events in reality occur, which may include, for example, changes in the orientation of the apparatus. The dynamic content is selected from a content group consisting of augmented reality content and virtual reality content. The computer-generated content comprises computer-generated content data encoding video. The computer-generated content and computer-generated content data are adapted to be generated based, at least in part, on the positioning data. The computer-generated content may be customized to the apparatus based on the computer-generated content data being generated after, but nearly simultaneous to, generation of the positioning data. The computer-generated content may be rendered and displayed on the display after, but nearly simultaneous to, generation of the computer-generated content. And, an occurrence of data generated, rendered, or displayed after, but nearly simultaneous to, generation of other data occurs within a latency not to exceed one second.

The data transfer device may be adapted to enable a data transfer between the console and a separate computing device, wherein the data transfer device may be adapted to enable the console to communicate with and transfer the electronic video feed data to the separate computing device and to enable the separate computing device to communicate with and transfer electronic data to the console. The data transfer device may include, for example, a wire cable, a wireless transceiver, or both. The console may be enabled to transfer to, and/or receive from, the separate computing device video data, software, and a configuration file, and the separate computing device may be enabled to transfer to the console other software and files. The wire cable, or a separate power cable, also may be adapted to power the console and/or enable the console to recharge the internal power source when the cable is coupled to an external power source.

In accordance with a second aspect of the invention, a system is disclosed that is adapted for use in displaying computer-generated content, in which the system comprises: a server; and an assembly, including an apparatus, the assembly or apparatus adapted to be coupled to and in communication with the server; wherein the server comprises: server electronic circuitry and hardware including: a server processor; a server memory, the server memory coupled to the server processor; a server data transfer module, the server data transfer module coupled to the server processor; a server data transfer device, the server data transfer device coupled to the server processor; server electronic software, the server software stored in the server electronic circuitry and hardware and adapted to enable, drive, and control the server electronic circuitry and hardware; and a server power supply connection, the server power supply connection coupled to the server electronic circuitry and hardware and couplable to a server power supply; wherein the apparatus comprises: apparatus electronic circuitry and hardware including: an apparatus processor; an apparatus camera, the apparatus camera coupled to the apparatus processor; an apparatus display, the apparatus display coupled to the apparatus processor; an apparatus memory, the apparatus memory coupled to the apparatus processor; an apparatus positioning device, the apparatus positioning device coupled to the apparatus processor; an apparatus data transfer module, the apparatus data transfer module coupled to the apparatus processor; an apparatus data transfer device, the apparatus data transfer device coupled to the apparatus processor; apparatus electronic software, the apparatus software stored in the apparatus electronic circuitry and hardware and adapted to enable, drive, and control the apparatus electronic circuitry and hardware; an apparatus power supply connection, the apparatus power supply connection coupled to the apparatus electronic circuitry and hardware and couplable to an apparatus power supply; and an apparatus housing, the apparatus housing comprising an apparatus interior and an apparatus exterior housing, the apparatus interior containing the apparatus electronic circuitry and hardware, the apparatus software, and the apparatus power supply connection; and the apparatus exterior housing comprising an apparatus frame. In some embodiments, the assembly may include an optional apparatus optical lens assembly, the apparatus optical lens assembly adapted to magnify and to focus an image rendered and displayed on the apparatus display; and the apparatus frame may be adapted to enclose the apparatus optical lens assembly. The assembly may further comprise a separate computing device, with which the apparatus or other components of the assembly share features and/or functions as a combination, in which features and functions are distributed between the components of the combination.

The apparatus positioning device is adapted to generate positioning data indicative of at least one parameter of a group consisting of a position, a location, an orientation, a movement, and a point of view of the apparatus. The apparatus is adapted to transmit the positioning data to the server. The apparatus is adapted to receive the computer-generated content from the server. The server is adapted to generate the computer-generated content based on receiving the positioning data from the apparatus. The server is adapted to transmit the computer-generated content to the apparatus upon generation of the computer-generated content. The computer-generated content includes dynamic content changing over time and space in real-time as related events in reality occur. The dynamic content is selected from a content group consisting of augmented reality content and virtual reality content. The computer-generated content comprises computer-generated content data encoding video. The computer-generated content and computer-generated content data are adapted to be generated by the server based on the positioning data. The computer-generated content is customized to the apparatus based on the computer-generated content data being generated after, but nearly simultaneous to, generation of the positioning data. The computer-generated content is rendered and displayed on the apparatus display after, but nearly simultaneous to, generation of the computer-generated content by the server. And, an occurrence of data generated, rendered, or displayed after, but nearly simultaneous to, generation of other data occurs within a latency not to exceed one second.

In an exemplary embodiment of the system, each apparatus unit may include at least one configuration of the plurality of configurations. A configuration may include, for instance, a map (e.g., an arial map, a road map, a topography map, a trail map, a resources map, a route map, a perspective view map, a plan view map, a point-of-view map, etc.), a user interface (“UI”) utility (e.g., switch points of view, reveal details, switch profiles, synchronization of accounts, etc.), a terrain (e.g., a city, a town, a village, a planet, a forest, a mountain, an ocean, a valley, a ghetto, a camp, an outpost, a mall, etc.), a tool (e.g., a weapon, a vehicle, a unit or type of ammunition, a unit or type of nutrition, etc.), a capability (e.g., flying, jumping, swimming, telepathy, invisibility, teleportation, etc.), an avatar (e.g., a warrior, a soldier, a spy, a ghoul, a troll, a giant, an alien, a monster, a vampire, a werewolf, a wizard, a witch, an elf, etc.), and a communication utility (e.g., a social media connection, a message feed, etc.). A user of the platform may include, for instance, a consumer, a producer, a performer, a business, a developer, an administrator, etc., or combination thereof. A user may create and/or distribute a configuration, or both, by using the platform for user-based creation and/or distribution of configurations. Each configuration may be software code in a configuration file that includes, for instance, one or more of a settings file, a configuration file, a profile file, an applet file, an application file, a plug-in file, an application programming interface (“API”) file, an executable file, a library file, an image file, a video file, a text file, a database file, a metadata file, and a message file. A producer user may develop the software code for the configuration file using, for instance, programming in coding languages, such as JavaScript and HTML, including open-source code, or object-oriented code assembly. The software code would be adapted to be compatible with and executable by the software of a console (e.g., an iPhone smartphone) on which a compatible video may be displayed, with which or within which the configuration would be used.

In an exemplary embodiment, the system may include the apparatus of the first aspect of the invention, in which the apparatus is adapted and configured to interact with the platform. The system further may be adapted to enable, permit, and allow a plurality of users to interact with each other, against each other, with one or more system-generated team members, against one or more system-generated opponents, or a combination thereof. The system may be adapted to enable, permit, and allow a user to associate content with a location, a topic, and/or a subject matter, and to push such associated content to another user who is at said location, who is interested in said topic, and/or who is connected to said subject matter.

In accordance with a third aspect of the invention, a method for is disclosed that is adapted for use in displaying computer-generated content, in which the method comprises: providing an apparatus, the apparatus adapted to be coupled to and in communication with a server; generating positioning data of and by the apparatus; transmitting the positioning data from the apparatus to the server; receiving the computer-generated content at the apparatus from the server; and rendering and displaying the computer-generated content on an apparatus display; wherein the apparatus comprises: apparatus electronic circuitry and hardware including: an apparatus processor; an apparatus camera, the apparatus camera coupled to the apparatus processor; an apparatus display, the apparatus display coupled to the apparatus processor; an apparatus memory, the apparatus memory coupled to the apparatus processor; an apparatus positioning device, the apparatus positioning device coupled to the apparatus processor; an apparatus data transfer module, the apparatus data transfer module coupled to the apparatus processor; an apparatus data transfer device, the apparatus data transfer device coupled to the apparatus processor; apparatus electronic software, the apparatus software stored in the apparatus electronic circuitry and hardware and adapted to enable, drive, and control the apparatus electronic circuitry and hardware; an apparatus optical lens assembly, the apparatus optical lens assembly adapted to magnify and to focus an image rendered and displayed on the apparatus display; an apparatus power supply connection, the apparatus power supply connection coupled to the apparatus electronic circuitry and hardware and couplable to an apparatus power supply; and an apparatus housing, the apparatus housing comprising an apparatus interior and an apparatus exterior housing, the apparatus interior containing the apparatus electronic circuitry and hardware, the apparatus software, and the apparatus power supply connection; and the apparatus exterior housing comprising an apparatus frame enclosing the apparatus optical lens assembly.

The apparatus positioning device is adapted to generate positioning data indicative of at least one parameter of a group consisting of a position, a location, an orientation, a movement, and a point of view of the apparatus. The apparatus is adapted to transmit the positioning data to the server. The apparatus is adapted to receive the computer-generated content from the server. The computer-generated content includes dynamic content changing over time and space in real-time as related events in reality occur. The dynamic content is selected from a content group consisting of augmented reality content and virtual reality content. The computer-generated content comprises computer-generated content data encoding video. The computer-generated content and computer-generated content data are adapted to be generated by the server based on the positioning data. The computer-generated content is customized to the apparatus based on the computer-generated content data being generated after, but nearly simultaneous to, generation of the positioning data. The computer-generated content is rendered and displayed on the apparatus display after, but nearly simultaneous to, generation of the computer-generated content by the server. And an occurrence of data generated, rendered, or displayed after, but nearly simultaneous to, generation of other data occurs within a latency not to exceed one second.

In an exemplary embodiment, the method further may be adapted for entertainment and/or education of a participant, in which the method comprises providing an apparatus adapted for interaction with the participant, in which the apparatus may be configured in accordance with the first aspect of the invention; configuring the apparatus to interact within the system; configuring the apparatus to interact with the participant; enabling the apparatus to interact with the participant; and adapting the apparatus to electronically process video data, configuration data, audio data, video AR-overlay data, or a combination thereof, of an interaction of the apparatus with the participant.

Further aspects of the invention are set forth herein. The details of exemplary embodiments of the invention are set forth in the accompanying drawings and the description below. Other features, objects, and advantages of the invention will be apparent from the description and drawings, and from the claims.

### BRIEF DESCRIPTION OF THE DRAWINGS

By reference to the appended drawings, which illustrate exemplary embodiments of this invention, the detailed description provided below explains in detail various features, advantages, and aspects of this invention. As such, features of this invention can be more clearly understood from the following detailed description considered in conjunction with the following drawings, in which the same reference numerals denote the same, similar, or comparable elements throughout. The exemplary embodiments illustrated in the drawings are not necessarily to scale or to shape and are not to be considered limiting of its scope, for the invention may admit to other equally effective embodiments having differing combinations of features, as set forth in the accompanying claims.

FIG. 1 shows a block diagram of an exemplary embodiment of an apparatus, according to aspects of the invention.

FIG. 2 shows a block diagram of an exemplary embodiment of a method of use of an exemplary apparatus, according to prior art of the invention.

FIG. 3 shows a block diagram of an exemplary embodiment of an operation of the apparatus of the present invention, according to aspects of the invention.

FIG. 4 shows a block diagram of an exemplary computer environment for use with the systems and methods in accordance with an embodiment of the present invention, and according to aspects of the invention.

FIG. 5 shows a block diagram of an exemplary system, and an exemplary set of databases for use within the exemplary computer environment, for use with systems and methods in accordance with an exemplary embodiment of the present invention, according to aspects of the invention.

FIG. 6 shows a block diagram of an exemplary embodiment of a method of use of an exemplary system, according to aspects of the invention.

FIG. 7 shows a conceptual block diagram of an exemplary system functions operation flow within systems and methods in accordance with an exemplary embodiment of the present invention, according to aspects of the invention.

FIG. 8 shows a conceptual block diagram of an exemplary apparatus operation, as an apparatus within a system used pursuant to a method in accordance with an exemplary embodiment of the present invention, according to aspects of the invention.

FIGS. 9A-9I show various views of screenshots of a graphical user interface of an exemplary apparatus operation, such as that of a smartphone, as an apparatus within a system used pursuant to a method in accordance with an exemplary embodiment of the present invention, according to aspects of the invention.

FIGS. 10A-10D show depictions of various media that may be used in an exemplary apparatus operation, as an apparatus within a system used pursuant to a method in accordance with an exemplary embodiment of the present invention, according to aspects of the invention.

FIG. 11 shows a block diagram of an exemplary architecture of exemplary components of an exemplary system, and an exemplary set of databases for use within the exemplary computer environment, for use with systems and methods in accordance with an exemplary embodiment of the present invention, according to aspects of the invention.

FIG. 12 shows a block diagram of an exemplary dataflow of an exemplary system, and an exemplary set of databases for use within the exemplary computer environment, for use with systems and methods in accordance with an exemplary embodiment of the present invention, according to aspects of the invention.

### LISTING OF DRAWING REFERENCE NUMERALS

Below are reference numerals denoting the same, similar, or comparable elements throughout the drawings and detailed description of the invention:
10000 an apparatus
   10010 an augmented reality console
      10012 an XR console
   10020 a participant
   10030 a power user
11000 an exterior housing
   11100 a frame
   11200 a handle
   11300 optics
   11400 eye cups
12000 an interior
   12100 electronic circuitry
      12110 an integrated electronic hardware system
         12111 an integrated camera
         12112 an integrated microphone
         12113 an integrated speaker
         12114 an internal processor
         12115 an internal memory
         12116 an internal power source
         12117 an integrated data transfer module
         12118 an integrated input button
         12119 a mini display
         12119′ an illumination device
      12120 an integrated software operating system
      12130 a dataset
         12132 a first profile
         12134 an augmented reality application
         12136 an AR configuration
13000 a data transfer device
14000 a positioning device
   14010 an accelerometer or inertia motion unit (IMU)
   14120 an infrared (IR) sensor
20000 a method of use of an AR apparatus 10000
   21000 a beginning detection
      21100 detecting the input button being activated
      21200 detecting a command
      21300 detecting motion of the apparatus
   22000 a beginning response
      22100 playing a greeting, displaying video, or other response
      22200 displaying an AR-overlaid video
   23000 a subsequent detection and response
      23100 displaying video
      23200 displaying AR overlay
      23300 recording video, with or without AR overlay
      23400 responding to further responses
   24000 an ending detection
      24100 detecting an ending
      24200 detecting the input button being activated
   25000 an ending response
      25100 playing a reply farewell to the first participant
      25200 storing a recording of the interaction as an interaction audiovisual file as a computer-readable file on a computer-readable storage medium
30000 a data transfer device
   30010 a wire cable
   30020 a wireless transceiver
31000 a data transfer
   31100 electronic data
      31110 a separate device software application
      31120 an interaction audiovisual file
      31130 a settings dataset
      31140 an image file
      31150 an AR app
      31160 an AR app configuration
   32000 an augmented reality console
      32100 an internal power source
   33000 a separate computing device
      33010 an auxiliary processing unit
         33012 a wireless transceiver
   34000 an external power source
40000 a computer environment
   41000 an augmented reality data system
      41100 an augmented reality apparatus
   42000 a network
   43000 a network connection
   44000 a computing device
      44100 a smart device
      44200 a mobile phone
      44300 a computer
   45000 a media server
      45100 a media account
         45110 media data selected for delivery to user device
50000 a data system
   51000 a computing device
      51010 an augmented reality apparatus console
      51100 a processor
      51200 a memory
      51300 a volatile memory and a non-volatile memory
      51400 a removable storage
      51500 a non-removable storage
      51600 a communications connection
      51700 an input device
      51800 an output device
   52000 a network
   53000 a server
   54000 a database
      54100 a database
      54200 a database
      54300 a database
      54400 a database
      54500 a database
      54600 a database
   55000 a tracking device
      55010 a beacon device
60000 a method of use of an augmented reality system
   61000 an image capture and positioning detection
      61100 detecting an input
      61200 detecting an image
      61300 detecting motion
   62000 a send of camera video output and inertia motion unit (IMU) data feed
      62100 sending camera video data feed
      62200 sending IMU data feed
   63000 a server computation and response
      63100 determining a point of view (POV) of video
      63200 computing an augmented reality (AR) overlay
      63300 sending an augmented reality (AR) overlay
   64000 a receipt and combination of responses
      64100 receiving an augmented reality overlay
      64200 combining an augmented reality overly and a video feed
   65000 a receipt and display of an AR-overlaid video
      65100 receiving a combined, AR-overlaid video feed
      65200 displaying the AR-overlaid video feed
70000 a system functions overview
   70010 a system
   70100 a server output, console input function
   70200 a console output, APU input function
   70300 an APU output, console input function
   70400 a console output, server input function
   71000 a server function
      71010 a server
   72000 a console function
      72010 a console
   73000 an auxiliary processor unit (APU) function
      73010 an auxiliary processing unit
80000 a system functions overview
   80010 a system
   80100 a server output, APU input function
   80200 an APU output, console input function
   80300 a console output, APU input function
   80400 an APU output, server input function
   81000 a server function
      81010 a server
   82000 an auxiliary processor unit (APU) function
      82010 an auxiliary processing unit
   83000 a console function
      83010 a console
90000 a system
   90010 a view
   90020 a view
   90030 a view
   90040 a view
   90050 a view
   90060 a view
   90070 a view
   90080 a view
   90090 a view
100000 media
   100010 media
   100020 media
   100030 media
   100040 media
   110000 a system architecture
110100 a client device
   110110 a headset
   120000
   110120 a personal computer
   110130 a mobile handheld device or smartphone
   110200 a backend platform
   110210 a network data connection
      110212 an Amazon® Web Services (“AWS”) Elastic Load Balancer (“ELB”)
   110220 a data connection
   110230 an API Gateway Service
   110240 an Application API
   110250 a Microservices Server Array
   110260 a Data Cache
   110270 a Datastore
   110280 a Stream Processing Pipeline
   110290 a Storage Solution
   110292 an AWS® Simple Storage Service (“S3”)
   110294 an Apache® Hadoop® Distributed File System (“DFS”)
120000 a dataflow
   120100 a client device
      120110 submit a request
   120200 an Amazon® CloudFront® service
      120210 send a request
      120220 stream audio data and video data to the requesting user's client device
   120300 a Lambda@Edge™ service
      120310 send a command to fetch a manifest
      120320 send an invoke MediaConvert Job command
      120330 send video audio files (e.g., audio playlist files in /*.m3u8 format) back to the Amazon CloudFront® service
   120400 an Amazon® S3 HTTP Live Streaming (“HLS”) bucket
      120410 send streaming video data files (e.g., video transport stream files having video data in /*.ts format) back to the Amazon CloudFront® service
   120500 an AWS Elemental MediaConvert™ service
      120510 fetch a source file (e.g., in mp4 format) for conversion
      120520 convert the file and save the file at the Amazon® S3 HLS bucket as a new HLD Rendition of the file
   120600 an Amazon® S3 media source bucket
      120610 send a file to the AWS Elemental MediaConvert™ service

### DETAILED DESCRIPTION OF THE INVENTION

The invention is directed to systems, methods, and apparatus involving a platform and an assembly and/or an apparatus adapted to provide an experience of augmented reality (“AR”), virtual reality (“VR”), and/or a combination thereof as a cross reality (“XR”). In an exemplary embodiment of the invention, the apparatus embodies an augmented reality apparatus that includes a handheld console, such as a smartphone. The apparatus may be adapted to operate as a configurable augmented reality console having electronics, such as a camera, a display, a microphone, a speaker, buttons, and a transceiver, coupled to and controlled by a processor, with the apparatus adapted to be connectable to the augmented reality platform, such as connectable to a media server or system, in a networked environment. In some embodiments, the console may be wired and connectable to a fixed location, such as a desktop computer operating a browser or desktop app, while in other embodiments, the console may include an internal chargeable battery and a radio-frequency transceiver, so that the console may be wireless and portable, such as a smartphone or tablet computer.

In some embodiments of the present invention, a system is provided that comprises an augmented reality platform that connects the augmented reality console to augmented reality overlaid video in a networked environment. The platform and system may provide a dashboard of, for instance, user activity, augmented reality video activity, and console status data.

In some embodiments, the system, methods, and apparatus may be geared mainly toward entertainment, autobiographical documentation, and/or social media interaction or communication. In some embodiments, video and configurations may be educational in nature and function as learning tools to develop, practice, or reinforce a user's skills or knowledge of specific information or content, such as a manual skill. Various embodiments of the inventions may use augmented reality in one or more of entertainment, education, guidance and training, communications, conferencing, trade shows, healthcare, air traffic control, and the auto industry.

Exemplary Commercial Embodiments of a Lifecache® System

A commercial embodiment of the present invention is being brought to the market under the trademark “Lifecache®” as the Lifecache® app, AR product, and system. The Lifecache® AR system is a proprietary client-server application that enables XR-enhanced “memories” or “moments” that be conceptualized as mini autobiographical documentaries, placing augmented reality content in the context of live activities. Unlike prior art devices, this system can achieve both augmented reality and virtual reality, depending on a mode of operation selected by a user. The Lifecache® mobile platform allows for the ability to capture, save, share, and manage immersive location-based-content experiences, referred to as “memories” or “moments,” that incorporate Augmented Reality, Virtual Reality, Mixed Reality, 2D-, 3D-, and/or 360-degree content.

The Lifecache® ecosystem links high quality video cameras, device displays, tracking technology, artificial intelligence (“AI”), embedded software, media servers, and real time image rendering, all working in tandem to create the augmented reality. The Lifecache® application allows consumers, businesses, media, and design teams to create a robust system inside a Lifecache® ecosystem.

The Lifecache® solution seeks to pioneer the mass adoption of immersive media incorporating Augmented Reality, Virtual Reality, and 360-degree digital experiences. The present invention is adapted to incorporate 360-degree content and pioneer a new way for creators of 360-degree content to manage and scale their content to the masses. The Lifecache® platform provides the first centralized ecosystem of immersive content experiences for both consumer and enterprise users. The Lifecache® system aggregates immersive media in an ecosystem conducive to the consumer experience, in a manner that ties electronically-captured, digital memories and/or moments into a location-based journey for people to explore and engage with, and that is supported by an integrated backend portal that enables content management and synthesizes information and analytics derived from the unique front-end experience. The Lifecache® application may be used with HMDs, AR glasses, smartphones, tablets, laptops, and/or desktop computer browsers to provide a versatile, dynamic, and rich experience that is easy to use and provides a mixture of AR functionality and access controls.

Exemplary components of a Lifecache® embodiment include within the Lifecache® device app an AR map, an AR view, a Moment or a Memory, a Trail, a camera mode or view, and a portal. An AR map may show the locations associated with memories, such as around a user, which may allow users to search for memory locations around the world. An AR view may comprise a street level view within the app that showcases and previews memories that are around you through Augmented Reality superimposed on the physical locations at which, and possibly in front of which, they occurred/are saved. A Moment or a Memory refers to an individual experience captured in and by the app. A Memory can include one or more 360-degree video(s), 360-degree photo(s), 2D traditional video(s), 2D image photo(s), 3D video(s), 3D image photo(s), and/or any combination thereof. A Trail is a linked group of Memories that have a common theme. Trails are meant to group similar Memories into a chronological journey for users to explore in sequence. The camera mode allows users to capture a Memory through the Lifecache® app or upload a Memory from the user's device to then be shared on the Lifecache® system. The Lifecache® system includes a backend web portal that allows for content management and collects analytics for both users and marketers to leverage. The portal may allow users to upload and associate a Memory with a specified location, to push the Memory to users in said specified location, and to generate performance analytics on Memories, such as user sentiment data, top-viewed Memories, most-viewed locations, engagement duration of Memories, etc. The Portal also may have administrative features to manage and administer each user's access. The Lifecache® system combines these features and functions to create an experience curated for immersive media and to create an ecosystem for creators, consumers, and businesses alike to share in a new media form.

A Lifecache® app may be is based on the iOS® mobile device operating system, the Android® operating system, another operating system, and/or be an interface running in a browser window, and may run on a mobile handheld device, such as a smartphone, tablet or laptop, and/or on a headset, such as an HMD. The Lifecache® system leverages a combination of AR Components, VR Components, Mobile Development, Headset Development, Software Development, Application Development, Web Components, Data Optimization, Database Components, API Calls, and Networking Technology.

A typical user may use the Lifecache® platform to create content (e.g., AR content, 360-degree photos or videos, 2D/3D photos or videos, URL media, etc.), manage content, share content, consume content, and/or push content from the Lifecache® portal to, or associate content with, a geographical location, based on addresses specified in Lifecache® portal when posting, pushing, or associating content. In some embodiments, the Lifecache® app may interoperate with another installed maps app or mapping app, such as SnapChat Map, Google Map, Google Street View. The Lifecache® system may both render photos based on location as well as allow users to create, manage, share, consume, associate, and push location-based AR experiences leveraging 360-degree photo or video content. Using the Lifecache® portal, the Lifecache® app enables a user to operate the specific functions allowing the user to push AR, 360-degree photo and video, and URL media to users at a specified location anywhere on an available map. For instance, a content creator or marketer may log into the Lifecache® portal from any Internet browser, or login to the Lifecache® mobile app, and upload and push content, such as 360-degree photos or videos to users who connect to the app while at a specific address or location on an available map. Such uploaded and/or pushed content then may be explored and rendered in an Augmented Reality experience for consumption on mobile and/or headset devices.

In some embodiments, for instance, a user may use a GoPro® camera to generate 360-degree photos or videos for use within an exemplary Lifecache® system, which would involve importing a corresponding file into the system. To import such a file into the system, the system may enable, for instance, one or more of the following actions: (1) implement a file upload feature in the mobile application that allows users to import their 360-degree files from the GoPro® Max device to the backend database; (2) provide a backend API that can handle the 360-degree files and store them in a format that can be easily shared and consumed by end-users at multiple locations; (3) implement a sharing feature that allows users to share the 360-degree files stored in the backend database with other users at multiple locations in real-time; (4) provide a content management system that allows users to organize and manage their 360-degree files in the backend database; (5) enable users to add location data to their 360-degree files so that the files can be easily discovered by other users who are in the same location; and/or (6) use machine learning algorithms to analyze the viewing patterns of users and provide insights on how to optimize the 360-degree files for better engagement and user experience.

The Lifecache® application works within a larger ecosystem, and its design is based on a mix of established standards and protocols used in video production and the creation of visual effects. Exemplary embodiments of this ecosystem might utilize or leverage the following exemplary technologies: (a) Unreal Engine by Epic Games: a visual rendering software originally designed for the gaming industry that has become the leader in real-time animation, visual effects for film & tv, and most VR/AR applications, which might provide the digital assets that may be overlaid onto the live video feed inside the Lifecache® ecosystem; (b) Disguise XR Media Server: the backbone or central control unit for visual media in video productions and live entertainment that recently has become the go-to device for use in Virtual Production, which might allow the Lifecache® application to communicate with the larger network and provide the scaling power to have just one or several thousand pairs of Lifecache®-app-running devices working in tandem; and (c) Open XR by Khronos Group: a cross-platform standard for VR/AR devices that enables applications and engines to run on any system that exposes the OpenXR APIs, wherein using this open-source software as the communication bridge might allow developers to use a Lifecache® application in the same way they would for other HMDs, like the Oculus, Vive Pro, or HP Reverb; and wherein the Lifecache® ecosystem might benefit from this OpenXR Technology as it may be compatible with all existing AR and VR products.

The Lifecache® system may achieve an AR experience by a process known as “digital pass-through” that transforms the real-world view of the user through a live video stream captured by a built-in camera and merges this data with CG objects generated by a real-time rendering software. The new “augmented” video is quickly displayed on an internal display, which might be magnified with a lens piece and/or multiple lenses. Instead of seeing the physical reality in front of them, the user may view an “augmented” reality by simply holding up and looking at a console running the Lifecache® system.

Every VR or AR device must compensate for the inherent time delay as data transfers from one device to another, also referred to as latency. To minimize the time between what happens in the real-world and the augmented version seen by the viewer, a console or server might include special-purpose processors, such as an Nvidia Jetson Xavier NX carrier board with the power of Artificial Intelligence (“AI”). For example, a front-facing camera of a console may capture a real-world view of the user and relay the video feed from the on-board driver inside the Lifecache® console to the Jetson carrier board.

For any VR/AR device to function properly, the device often must run in tandem with several external and/or internal devices, creating a larger ecosystem of hardware and software. Two important pieces of equipment for a quality experience may include a high-powered computer and graphics interface. In the case of the Lifecache® system, the Lifecache® console needs a faster, higher-power processor, possibly including a dedicated CPU, that integrates with network server being used in the live video capture. In addition, the Lifecache® system may include a dedicated media server having solid real-time image rendering software, which may be required to produce the virtual CG elements that overlay on top of the real-world video feed provided by the camera described above. An exemplary embodiment may include the Unreal Engine by Epic Games for real-time rendering. The Unreal Engine is used by many developers to create best-in-class visual graphics for Hollywood VFX, AAA Games, Virtual Production, and Live Broadcast. At the point in the process at which the server receives the video data and the positioning data, the Unreal Engine utilizes its real-time power.

Using the tracking data of sensors on a Lifecache® console, such as a smartphone having, for example, a GPS receiver and a light detection and ranging (LiDAR) system, and the virtual assets stored on the server or the console, the software renders out the digital overlay based on the exact perspective of the individual viewer's Lifecache® console. In some embodiments, the same data transfer connection or module that brought the tracking data may be used by the media server to send back the real-time virtual overlay. Using the Nvidia Jetson technology, for instance, a carrier board may be adapted take the live video feed from the camera and overlay the virtual images received from the media server. The augmented images then may be instantaneously rendered on the console display. In some embodiments having optical eye pieces, the images running on the display may be magnified through right and left eye pieces, in the same manner as a pair of binoculars or microscope. In some embodiments, an assembly having both right and left eye pieces and lens assemblies may also include dual displays adapted to display stereoscopic images generated by the system.

The Lifecache® system uses software having various libraries and communication protocols used to provide an Artificial Intelligence (AI)-powered Augmented Reality overlay to the Lifecache® system, which may run, for example, on Jetson Xavier NX board. As discussed more below, such software may include: (a) ROS2 Robotic Operating System, and (b) the OpenXR Library. The Lifecache® system may use AI to synthesize data on the Lifecache® experience to provide users with a tailored immersive journey with carefully curated content relevant, for instance, to a user's location, history, and interest profile.

Further implementations of AI may include, for example, that the Lifecache® system may: (01) use AI-powered recommendation engines to suggest personalized content based on the user's interests, location, and historical interactions with the platform; (02) integrate AI-powered natural language processing to enable users to search for specific content using voice commands; (03) implement AI-powered image recognition technology to identify landmarks and other objects in the user's surroundings and provide relevant information and content; (04) use AI-powered chatbots to enhance the user experience by providing instant customer support and personalized recommendations; (05) use AI-powered predictive analytics to anticipate user behavior and preferences, enabling the platform to offer personalized content and travel recommendations; (06) implement AI-powered sentiment analysis to track user feedback and sentiment, enabling the platform to make data-driven decisions about content curation and platform improvements; (07) use AI-powered geolocation technology to track user movements and preferences, enabling the platform to offer personalized content and recommendations based on their location history; (08) integrate AI-powered user profiling to identify patterns in user behavior and preferences, enabling the platform to offer personalized content and recommendations; (09) use AI-powered natural language generation to create personalized travel itineraries for users based on their interests, location, and travel history; and (10) implement AI-powered image and video recognition to detect and remove inappropriate and offensive content from the platform.

The ROS2 Robotic Operating System may be adapted to provide the communication and modularity between the server and the Jetson Xavier NX inside a Lifecache® system, which may be handled by the ROS2 Library, which includes a set of libraries for distributed systems, where each program is represented as a node. Nodes can communicate with each other in two possible ways: (1) Publisher-Subscriber Communication (one-to-many): a publisher node pushes messages on a given topic to which other nodes subscribe, and messages are received through the subscription; and (2) Service-Client Communication (one-to-one): a client node sends a request to a server node, and once the server node handles the service request, it sends the response back to the client.

ROS2 supports running nodes in a single process (all nodes run concurrently in a single process), in multiple processes (nodes run in different processes within a single machine), and across various devices. Depending on the localization it picks the best means of transport for topic messages, service requests, and responses.

Apart from intra-process and inter-process communication of parallelly running nodes, the ROS2 library provides numerous useful data packets and libraries for vision, robotics, and system control. Another advantage of using ROS2 is the requirement of explicitly defining the message and service data structures using specification files to make the communication concise. ROS2 also supports both C++ and Python scripting. A commercial embodiment system may use the newest distribution release of ROS2, presently Galactic Geochelone at the time of filing.

OpenXR Library is an open standard for extended reality libraries, implementing drivers for a Head Mounted Display (“HMD”) and an Application Programming Interface (“API”) for applications running Virtual Reality (“VR”) and Augmented Reality (“AR”) features (collectively referred as “XR”). OpenXR can be thought of as OpenGL for VR/AR, not providing the implementation, but the API. The implementation is dependent on the running operating system and there are various implementations of OpenXR that are conformant with the standard.

Monado is an open-source implementation of the OpenXR library that is fully conformant with the OpenXR standard, according to its published tests. Monado fully supports Linux OS and has partial support for Windows. The Monado implementation of OpenXR is referred as the “OpenXR Library” by some developers.

The OpenXR Library acts as integrator between HMD hardware and the rendering libraries (such as OpenGL, Vulkan, Unity, or Unreal Engine 4). The OpenXR Library can fetch and process data from various XR related sensors, such as hand controllers, HMD sensors, and trackers, and communicate them via semantic paths (i.e., /user/head represents inputs from the on the user's head, coming from HMD, while /user/hand/left represents the left hand of the user).

The OpenXR Library handles the interactions between the reality and the rendered scene, first localizing the user in the rendered space and then rendering the HMD view based on the user's state. Such a process may occur on the Jetson Xavier NX board, rendering the final views displayed inside the console.

The computer-generated (“CG”) content providing the visual overlay for the AR display may be rendered on a remote server. The rendered content may be sent in the form of a texture representing the various perspectives or viewpoints of the rendered scene. This texture may be packed into a single ROS2 message or node called Surrounding Texture.

An exemplary commercial embodiment of the Surrounding Texture node may use a volumetric cube, which provides a texture with 6 faces or points. Other volumetric shapes containing more individual faces (e.g., cylinder, sphere, etc.) may be used, once fully tested. The choice of volumetric shape or number of faces necessary is dependent on the AR function being performed by the exemplary system. This dependency allows for more flexibility in the artistic design and provides a technical production solution for scaling up or down.

The Surrounding Texture node may be conceptualized as a transparent image representing the following 6 points of a cube: +X right view; −X left view; +Y top view; −Y bottom view; +Z front view; −Z back view. The initial direction of the points, for example, may be the vector pointing towards the center of the stage or one perpendicular to the viewing area. The cubic texture is extracted from the scene using framebuffers inside the designated render engine. In the case of an exemplary console, this framebuffer might be the equivalent frame buffer inside Unreal Engine 4 (“UE4”). As the direction of the point of view is changed, respective of the initial direction, a framebuffer is extracted with the desired resolution. The 6 points or volumetric faces of the rendered scene may be packed into a single ROS2 message by the remote server. This Surrounding Texture Node may be sent to and received by a Jetson Xavier NX for the final image processing to create the Augmented Reality.

An exemplary embodiment for the Augmented Reality system may create a ROS2-based distributed system between the remote rendering server and the device based on the Jetson Xavier NX module. For example, the remote server may be adapted to: (1) render the AR content only of a 3D scene using a real-time render engine (i.e., UE4); (2) create a surrounding texture for a single point in the scene; and (3) pack it into a ROS2 message and publishes it under the/render_server/surroundingtexture topic. The ROS2 publishing can be handled inside UE4 with blueprint codes or in the C++ implementation, depending on the implementation method. Likewise, for example, the Jetson Xavier NX may be adapted to: (1) subscribe to /render_server/surroundingtexture topic; (2) collect the new Surrounding Texture when it arrives; (3) fetch the camera frame and IMU sensor data from the console; (4) render the camera view and Surrounding Texture using OpenGL to create the augmented view; and (5) using OpenXR, combine the augmented view with the sensory data and render the final view for the device's internal displays.

Alternate embodiments may include generating Surrounding Texture for multiple points in the scene simultaneously to capture different points of view and publish them under different topics. Each console then may pick the Surrounding Texture that is closest to the console. This grouped broadcast process may create the potential of scaling the number of devices used at once using the same AR content in the AR system.

The aforementioned system integrations may be used to provide a robust system architecture and performance. Moreover, the Lifecache® system may include various Lifecache® portal integrations for enhanced dataflow. The Lifecache® system may employ, for instance, an Augmented Reality Development Kit (ARDK) and/or Visual Positioning System (VPS) as a portal integration with the Lifecache® Database System. In an exemplary embodiment, a Lifecache® system allows users to create user-generated content and manage the content using a database integrated with VPS using ARDK.

An exemplary implementation of such a feature might work as following: (1) When a user creates new content, the implementation captures the relevant VPS data, such as the user's location, orientation, and placement of the content in the real world. These data are stored in the Lifecache® database. (2) The Lifecache® system uses VPS to anchor the user-generated content to the real world location where the content was created. This anchoring ensures that the content remains in the correct location, even if the user leaves and returns later. (3) The Lifecache® system allows users to manage their content using the database, such as editing or deleting content. The database also is used to provide search and filtering functionality for the user-generated content. (4) The Lifecache® system leverages a custom integration with ARDK to render the user-generated content in the augmented reality view, so that other users can see and interact with it. Thus, the Lifecache® system may integrate VPS with the database and use ARDK for rendering to ensures that user-generated content is properly anchored to the real world and can be managed and displayed in a consistent and accurate manner pulling content from the lifecache database.

Separately, the Lifecache® system may ensure that user-generated content is visible only to authorized users with an authentication and authorization system. This security process may require, for example, that a user to log in with a unique identifier including the user's email or social media account. The Lifecache® database may be customized and configured to only display content created by the logged-in user or content that has been shared with them by other users. To further enhance the user-generated content, the Lifecache® system may use machine learning algorithms to analyze the content and provide recommendations to the user. For example, a Lifecache® algorithm may be able to suggest related content or provide feedback on the quality of the content. The Lifecache® system may be configured so that the user-generated content is optimized for performance and doesn't impact the overall performance of the platform, such as by implementing, for example, caching strategies, including storing frequently accessed data in memory and using a content delivery network (CDN) to serve the content. A Lifecache® system continuously may monitor and analyze the user-generated content to identify any potential security or privacy issues, using, for example, automated tools and by assigning a team to manually review the content.

Management of the content impacts and relates to management of the corresponding databases and data therein, including access to those data and the files that contain those data. In an exemplary embodiment, on the platform side, the Lifecache® system may include an integration of the Lifecache® Database System with the AR Cloud provided by Magic Leap® using an implementation of the ARDK and/or VPS. In such an embodiment, the system may provide a Magic Leap® AR Cloud Developer Kit that can be used to integrate the Magic Leap® AR Cloud into existing platforms with an existing database. The Kit also may be used to integrate the content of the existing database to an ARDK/VPS provided by Niantic®. The system may provide APIs that can be used to connect the Magic Leap® AR Cloud to the existing database and also to an ARDK/VPS instance. This provision may enable seamless integration between the two platforms, and also make the sharing and accessing of data between them easier. The system may implement a synchronization mechanism that can ensure that data from the existing database is always up-to-date in the Magic Leap® AR Cloud and ARDK VPS. This synchronization may facilitate and enable users to get the most accurate and relevant information in real-time.

On the user side, the system further may provide a dashboard that can be used to manage and monitor the integration between the Magic Leap® AR Cloud and the ARDK VPS. This dashboard may enable developers to track usage, identify issues, and make necessary improvements to the integration. The system also may include a user-friendly interface that can be used to access and interact with the Magic Leap® AR Cloud content. This user interface may enable users to more easily find and use the content they need. Moreover, the system may implement a search and filtering functionality that can be used to quickly find the content that is most relevant to and/or sought by the user. This functionality may enable users to more easily access the content they need without having to sift through irrelevant data. The system may leverage the accuracy of ARDK VPS data by integrating it into the Magic Leap® AR Cloud content. This leverage may enable users to experience more accurate and immersive AR content. In addition, the system may use machine learning algorithms to analyze user behavior and provide personalized recommendations for the Magic Leap® AR Cloud content. This functionality may enhance the user experience and drive engagement. As a bridge between the platform and the user, the system may provide a content management system that is adapted and/or configured to allow users to organize and manage their Magic Leap® AR Cloud content. This data management may enable and facilitate that the content is always up-to-date and relevant. Separately, the system may implement a security and privacy framework that is adapted and/or configured to secure user data, such that user data is continuously protected and maintained in a secure manner. This security may build trust with users and promote compliance with any relevant regulations.

### Drawings of Exemplary Embodiments of the Invention

Referring to the Figures, an apparatus may comprise a computing device operable as a video console, may be connectable to an augmented reality platform via a networked environment, and may comprise part of and/or communicate with a media server platform or system, which may include a data system, including at least one server and at least one database, and a network system, including computing devices in communication with each other via network connections.

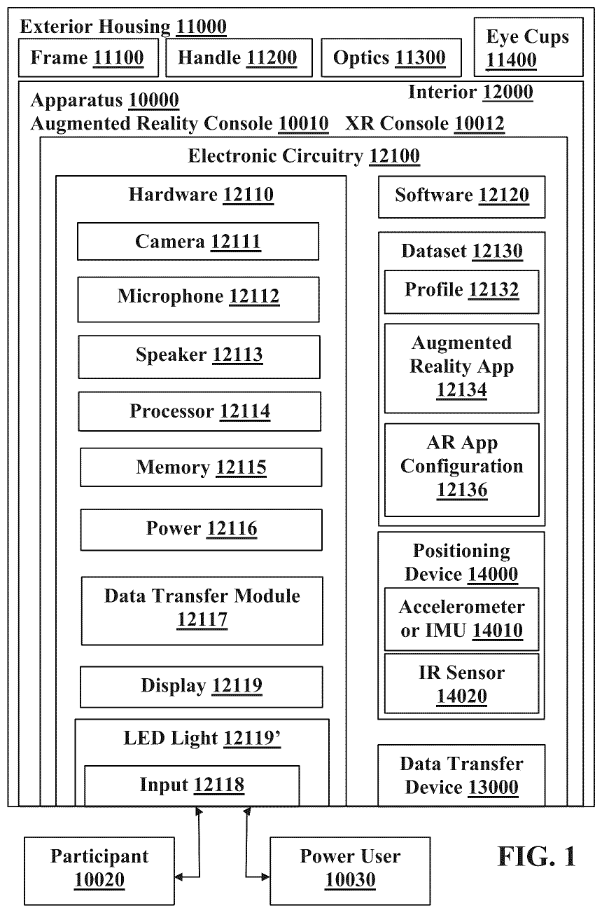

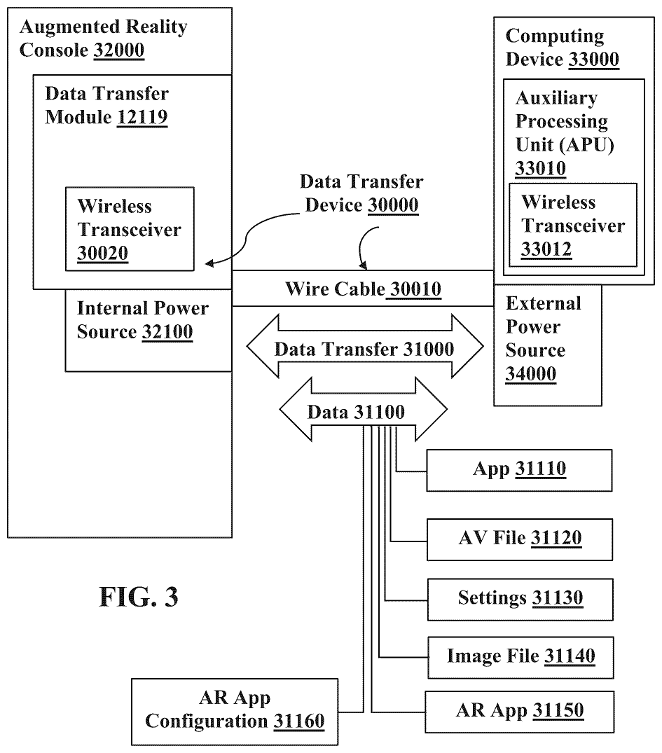

Referring to FIG. 1, FIG. 1 shows a block diagram of an apparatus 10000 adapted to comprise and/or operate as an AR console 10010, and more specifically a configurable XR console 10012, or other configurable device like a tablet computer or smart device, such as a mobile smartphone. The apparatus 10000 may be self-contained, if sufficient computing power and memory are integrated therein, or the apparatus 10000 may comprise and/or interoperate with a separate computing device, as depicted in FIG. 3 et seq. The apparatus 10000 may be configured for interactive communication adapted for entertainment and education of participants 10020. As explained below, the apparatus 10000 may be a part of a larger system, such as an augmented reality platform and/or a virtual reality platform or system. As depicted, the apparatus 10000 comprises a video console 10010, having an exterior housing 11000, such as that of a configurable XR video console 10012, and having an interior compartment 12000 containing electronic circuitry 12100. The housing 11000 may include a frame 11100, an optional handle 11200, an optional lens assembly or optics 11300, and optional eye cups 11400. Each optical lens assembly 11300 preferably includes an eye cup 11400 adapted to conform to a shape of a user's face surrounding an eye socket of the user. As such, the eye cup 11400 may be made from a suitably pliable, resiliently bendable and distortable material, such as rubber, silicon, vinyl, etc. The frame 11100 may define the interior 11000 and enclose the optical lens assembly.

The apparatus 10000 includes a data transfer device 13000 adapted to interoperate with the electronic circuitry 12100. The data transfer device 13000 may include one or more wired and/or wireless communication modules, as explained in further detail relative to FIG. 3.

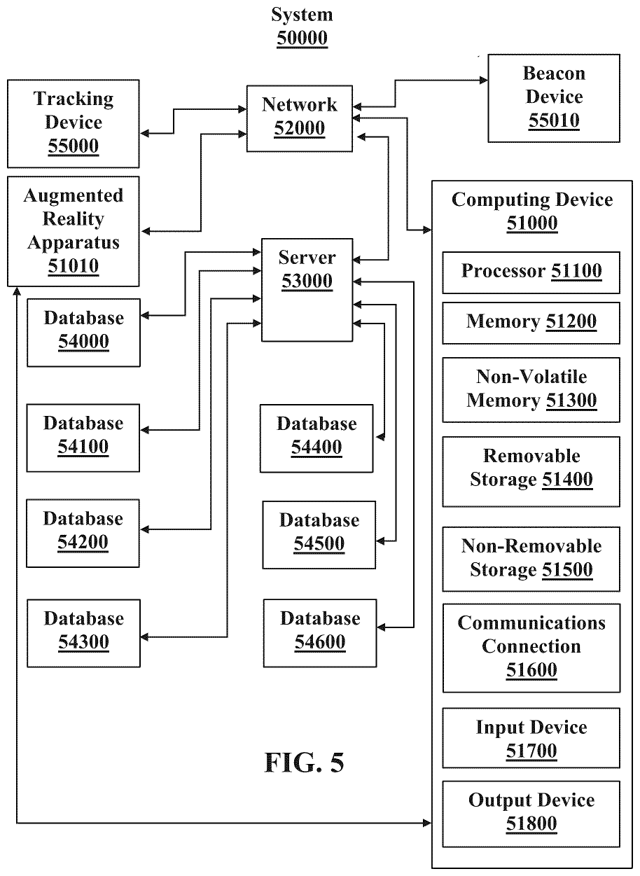

The apparatus 10000 includes a positioning device 14000 adapted to generate positioning data for use in determining the position, orientation, movement, motion, and/or perspective of console 10010. The positioning device 14000 also may be called a position measurement device. The positioning device 14000 generates data about the relative position of the apparatus, but does not “position” the apparatus, in the sense that a gimble might “position” or a tripod might support the apparatus in a fixed position. The positioning device 14000 may include a global positioning system (GPS) receiver and/or GPS module, from which an “absolute” position relative to Earth might be measured and calculated. In some embodiments, the importance of the positioning device 14000 for the apparatus 10000 may relate more to the relative point of view of the apparatus 10000 than to the absolute location of the apparatus 10000. Exemplary positioning devices 14000 may include a gyroscope, an accelerometer, an inertia motion unit (IMU) 14010 and/or an infrared (IR) sensor 14020 or other sensor that may be adapted to detect on-stage beacons or other tracking devices (see FIG. 5) that emit signals suitable for triangulation of a location of the console 10010. In some embodiments, a sensor may comprise a sensor-transmitter pair (e.g., light detection and ranging (“LiDAR”), or laser detection and ranging (“LaDAR”)) for active range determinations. Alternatively, the software 12120 may be programed to recognize in-view artifacts (e.g., identifiable background objects, like the Eiffel Tower), captured in the video data by the camera 12111, using machine vision and/or artificial intelligence (“AI”) for determination of the location of the console 10010, such as using triangulation or comparable AI calculation.

The electronic circuitry 12100 includes an integrated electronic hardware system 12110 and an integrated software operating system 12120 stored and executable on the integrated electronic hardware system 12110. The software 12120 may include, for example, firmware, an operating system, applications, drivers, libraries, and application programming interfaces. The electronic software 12120 may be stored in the electronic circuitry 12100 and hardware 12100 and may be adapted to enable, drive, and control the electronic circuitry 12100 and hardware 12100. The integrated electronic hardware system 12110 may include, for instance, one or more printed circuit boards (“PCB”), such as a motherboard, integrating an integrated camera 12111, an integrated microphone 12112, and an integrated speaker 12113 coupled to an internal processor 12114 coupled to an internal memory 12115 an internal power source 12116, an integrated data transfer module 12117 interoperable with the data transfer device 13000, and at least one integrated input device 12118 (e.g., button, switch, dial, slider, keypad, keyboard, joystick, touchpad, touchscreen, fingerprint sensor, camera, photosensor, infrared sensor, microphone, audio sensor, motion sensor, gyroscope, accelerometer, inertia motion unit (“IMU”), etc.) operable from without the exterior housing 11000. The processor 12114 may include a central processor unit (“CPU”), a graphics processor (i.e., a graphics card or video card), or combination thereof. The software 12120 and the hardware 12110 may be adapted to enable a power user 10030 to set up the configurable video XR console 10012, such as to create in the software 12120 and store in the memory 12115 a dataset 12130 including a first profile 12132 identifying a first participant 10020, and to download, install, select, and run an augmented reality app 12134 and an AR app configuration 12136 for, and compatible with, a configurable app, such as AR app 12134.

The hardware 12110 further includes a portable, small or mini display 12119, and possibly two mini displays 12119 (such as one display per eye, such as in embodiments adapted to generate stereoscopic renderings to be viewed by both eyes in tandem), and wherein the software 12120 is adapted to render on the display 12119, for instance, a reality-based video, an AR-overlaid video, a VR video, a settings menu, an audiovisual file, an image file, on-screen text, on-screen text-entry icons, or any combination thereof. In some embodiments, the display 12119 is touch-sensitive. Although the display 12119 may emit light, such as using a backlight or illuminated pixels (e.g., such as in displays in which each pixel is an organic light emitting diode (“OLED”)), the hardware 12110 further may include a simple illumination device 12119′ adapted to illuminate at least a portion of the exterior housing 11000. For instance, the illumination device 12119′ may include a light emitting diode (“LED”) adapted to illuminate a portion of the exterior housing 11000 surrounding the input button 12118. An LED light 12119′ may indicate a status of the console 10010.

Various data settings of the apparatus 10000 may include creating the first profile 12132 to include, for example, entering a first name of the first participant 10020 or power use 10030, or a name of an autobiographical event (e.g., a “memory” or a “moment”), and storing a first face image of a face of the first participant 10020 or power use 10030, or an image indicative of the moment. The camera 12111 and the software 12120 may be adapted to recognize the face of the first participant 10020 or power use 10030 based on a comparison with the first face image. The user may associate the first face image with the user's profile for inclusion in the user's postings on the online gaming platform or social media system. Moreover, the configuration 12136 may be specific to the user's profile and may be configured to load automatically upon recognizing the face of the first participant 10020 or power use 10030 within a specified distance of the apparatus 10000.

Among other possible variations, the software 12120 may be further adapted to enable the power user 10030 to select one of a plurality of languages programmed into the software 12120; to select one of a plurality of settings programmed into the software 12120; to set up the first profile by entering first profile parameters including a first performance, a first role, a first position, a first location, a first event, etc., or any combination thereof, relative to the first participant and/or first memory or moment; and to configure the software 12120 to adjust interaction parameters based on the first profile parameters entered.

Technical variations may include, for example, having the camera 12111 and the software 12120 adapted to measure ambient light, motion, or both, such that the apparatus 10000 may be adapted to alternate between an inactive state and an active state based on measuring a presence or an absence of a minimum threshold of ambient light, motion, or both.

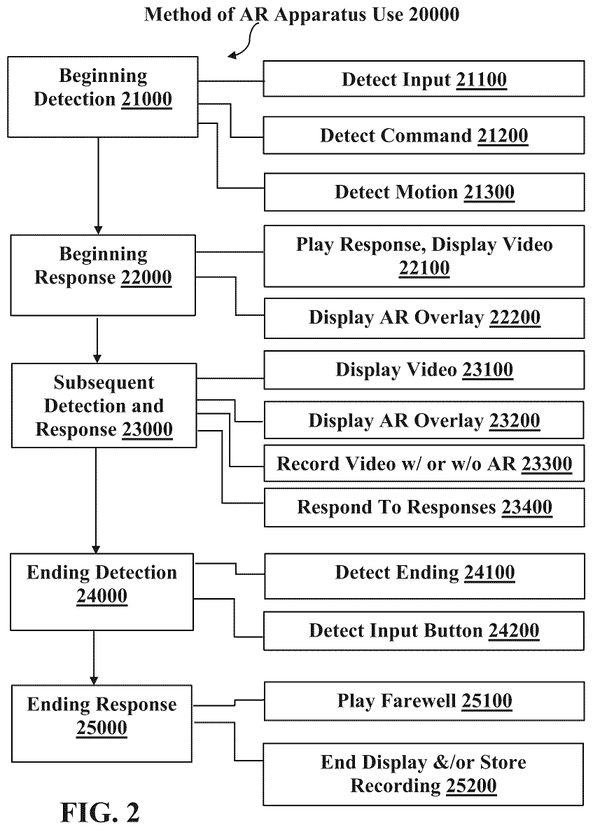

Referring to FIG. 2, FIG. 2 shows a flow diagram of an exemplary method 20000 of using an AR apparatus 10000, such as the apparatus 10000 of FIG. 1, according to aspects of the invention. The method 20000 may be adapted to perform, upon detecting an AR app configuration 12136, loading a configuration beginning detection 21000, a beginning response 22000. For example, the beginning detection 21000 may include detecting the input button being activated (21100), detecting a command being provided (21200), detecting motion of the console (21300), or any combination thereof. Likewise, the beginning response 22000 may include using the speaker to play audio or display video (22100), such as a greeting identifying the first participant 10020, to display an AR overlay (22200), such as instructing the first participant 10020 what to do to capture a memory or a moment, or to activate the input button 12118 to launch the AR configuration 12136, or both, upon detecting the beginning detection 21000. Following the beginning response 22000, the method 20000 may be adapted to perform a subsequent detection and response 23000, such as display video 23100 from the camera 12111, display an AR overlay 23200 in the video feed, record video (with or without AR overlay) 23300 as an interaction audiovisual file in the memory 12115, such as a AR-overlaid video (23300) of an interaction (e.g., a recorded moment being viewed, or a moment being recorded) of the first participant 10020 with the video console 10010, during which interaction the video console 10010 may use the speaker 12113 to play a plurality of verbal instructions or other recordings (23400) responsive to input or verbal responses of the first participant 10020.

The configured apparatus 20000 may be configured to have the software 12120 and the hardware 12110 further be adapted to enable a power user 10030 to set up the apparatus configuration 20000 to select an ending detection 24000 and an ending response 25000 to the ending detection 24000, wherein the method 20000 further is adapted to perform the ending response 25000 upon detecting the ending detection 24000. The ending detection 24000 may include, for instance, detecting an ending 24100, such as the end of the moment, detecting the input button 24200 being activated, such as to discontinue viewing, or both, and the ending detection 24000 may initiate the ending response 25000 that concludes an interaction of the method 20000 with the first participant 10020. The ending response 25000 may include using the speaker to play a reply farewell 25100 to the first participant, ending the display of the video feed, and/or storing a recording 25200 of the interaction as an interaction audiovisual file as a computer-readable file on a computer-readable storage medium. The ending response 25000 might also include connecting to the network, connecting to a media server or platform, and sending an alert to the power user to notify the power user that a participant has concluded interacting with the apparatus 10000 and that a video of the interaction may be available on the media server and/or stored in the video console 10010.

Referring to FIG. 3, FIG. 3 shows a block diagram of an exemplary embodiment 30000 of the present invention specific to a data transfer device 13000. A data transfer device 30000 may be adapted to enable a data transfer 31000 between an AR console 32000 and a separate computing device 33000, such as to provide additional computing, video-capturing, video-processing, image-capturing, image-processing, data processing, communicating, networking, and/or storing capabilities, such as including an auxiliary processing unit (“APU”) 33010 or a server of an AR platform, wherein the data transfer device 30000 may be adapted to enable the AR console 32000 to communicate with and transfer electronic data 31100 to the separate computing device 32000 and to enable the separate computing device 33000 to communicate with and transfer electronic data 31100 to the AR console 32000. For example, in situations in which multiple consoles may attempt to communicate with a backend server simultaneously from the same general location, such as while users attend a sporting event at a stadium, a computing device 33000 may act as an intermediate buffer, data aggregator, network bus, cache, or router to facilitate simultaneous high-volume, high-data communication between multiple local consoles and a backend system server over the Internet. In some embodiments, the computing device 33000 may comprise a separate camera, such as for 360-degree video capture.

The data transfer device 30000 may include, for instance, a wire cable 30010, a wireless transceiver 30020, or both, possibly in combination with wireless transceiver 33012 of APU 33010, wherein the AR console 32000 may be enabled to transfer to, or receive from, the separate computing device 33000, for example, a separate device software application 31110 and an interaction audiovisual file 31120. Wired cables may include, for instance, an Ethernet cable, RJ45 cable, coaxial cable, USB cable, Thunderbolt cable, Lightning cable, HDMI cable, VGA cable, MIDI cable, etc. A wireless transceiver 30020, 33012 may comprise, for instance, a Wi-Fi transceiver; WiLAN transceiver; a Bluetooth transceiver or a Bluetooth Low Energy (BLE) transceiver; a 1G, 2G, 3G, 4G, or 5G cellular transceiver; a Long-Term Evolution (LTE) cellular transceiver, etc. Likewise, the separate computing device 33000 may be enabled to transfer to, or receive from, the AR console 32000, for instance, a settings dataset 31130 and an image file 31140. For example, an app 31110 might include an AR app 31150, and settings 31130 might include an AR app configuration 31160. In addition, the wire cable 30010 may be adapted to enable the AR console 32000 to recharge an internal power source 32100 when the wire cable 30010 is coupled to an external power source 34000. An internal power source 32100 may include, for instance, a rechargeable battery, a non-rechargeable battery, a battery backup, an uninterrupted power supply (“UPS”), a solar-powered generator, a photovoltaic cell or array of cells, etc.

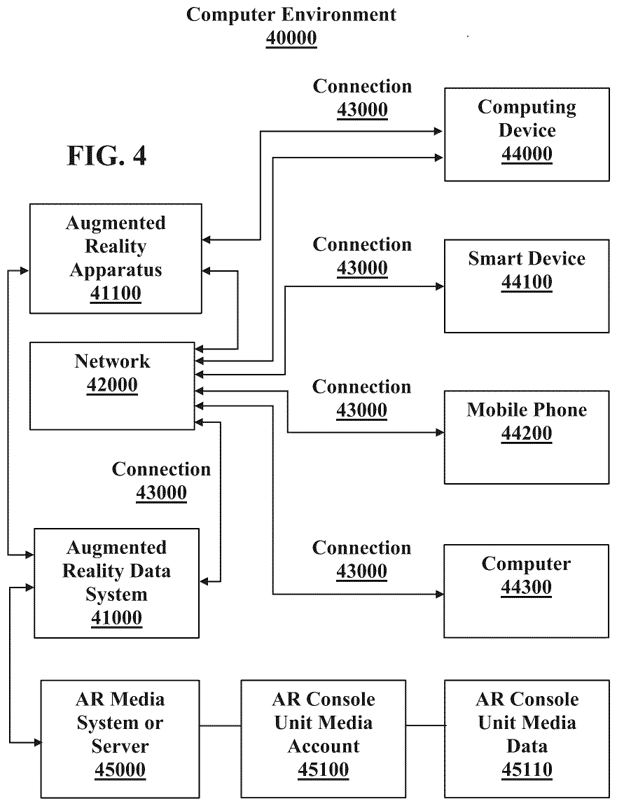

Referring to FIGS. 4-5 below, exemplary embodiments of the present invention may include a system for interactive communication adapted for entertainment and/or education of a participant, wherein the system comprises an AR platform, and possibly an integrated media server platform, a networked media server, and/or a third-party media server, platform, or service, and an apparatus adapted to interact with AR platform and the media platform. The system further may comprise a separate device software application running on at least one separate computing device, wherein the separate device software application may be adapted to enable the separate computing device to interact with the AR console, modify settings of the AR console, upload data and files to the AR console, download data and files from the AR console, and control features and functions of the AR console.

The system further may comprise a remote computing network and a user account platform accessible via the remote computing network and adapted to communicate with and transfer electronic data to and from the AR platform and the AR console, adapted to communicate with and transfer electronic data to and from the separate computing device, and adapted to enable the AR console to communicate with and transfer electronic data to and from the separate computing device via the remote computing network. The system further may comprise a user account accessible via the user account platform that enables the power user to log into the user account to remotely manage, view, and share data and settings of the AR console and the user's account on the AR platform that are available in the user account via the remote computing network, either because the data and settings have been uploaded to the user account platform, or because the AR console is in communication with the user account platform via the remote computing network while the power user is accessing the user account platform and logged into the user account. In some embodiments, the user account may be adapted to enable the power user to set alert options to have an alert generated and sent to the separate computing device if an interaction with the first participant happens and notification of the interaction has been communicated from an AR console and the user account platform via the remote computing network. The user account further may be adapted to enable the power user to email, upload, download, otherwise electronically share, or any combination thereof, an AR app, an AR app configuration, or other data file, such as an interaction audiovisual file of a recording of an interaction of the first participant with the AR console.

The system further may comprise an AR app configuration data file stored on the remote computing network and downloadable from the user account platform to the separate computing device and to the AR console, wherein the AR configuration data file is adapted to enable the AR console to add further features, perform additional functions, or both. An AR configuration may include, for instance, details relevant to a performance or experience, such as a map (e.g., an arial map, a road map, a topography map, a trail map, a resources map, a route map, a perspective view map, a plan view map, a point-of-view map, etc.), a user interface (“UP”) utility (e.g., switch points of view, reveal details, switch profiles, synchronization of accounts, etc.), a terrain (e.g., a city, a town, a village, a planet, a forest, a mountain, an ocean, a valley, a ghetto, a camp, an outpost, a mall, etc.), a tool (e.g., a weapon, a vehicle, a unit or type of ammunition, a unit or type of nutrition, etc.), a capability (e.g., flying, jumping, swimming, telepathy, invisibility, teleportation, etc.), an avatar (e.g., a warrior, a soldier, a spy, a ghoul, a troll, a giant, an alien, a monster, a vampire, a werewolf, a wizard, a witch, an elf, etc.), and a communications utility (e.g., a social media connection, a message feed, etc.). At the level of the AR console, the further features might be selected from the group consisting of further music recordings, further video recordings, further voice recordings, and further illumination patterns; and wherein the additional functions might be selected from the group consisting of additional alert options, additional rules options, additional language options, additional voice recognition options, and additional video recognition options.

A user of the AR platform may be, for instance, a consumer of AR video, a business, a retailer, an advertiser, a concert goer, a theater goer, a performer, a producer, a developer, an educator, a trainer, an advertiser, a vendor, or any combination thereof. A user may create and/or distribute a memory, or moment, including an AR video, an AR configuration, or both, by using the AR platform for user-based creation and/or distribution of AR videos, AR overlays, and AR configurations. Each AR configuration may be software code in a configuration file that includes, for instance, one or more of: a settings file, a configuration file, a profile file, an applet file, an application file, a plug-in file, an application programming interface (“API”) file, an executable file, a library file, an image file, a video file, a text file, a database file, a metadata file, and a message file. A user may develop the software code for the AR configuration file using, for instance, programming in coding languages, such as JavaScript and HTML, including open-source code, or object-oriented code assembly. The software code would be adapted to be compatible with and executable by the AR software of an AR console on which a compatible AR video may be displayed, with which or within which the AR configuration would be used.

Referring to FIG. 4, FIG. 4 shows a diagram of an exemplary computer environment for use with the systems and methods in accordance with an embodiment of the present invention, and according to aspects of the invention. FIG. 4 illustrates a schematic diagram of an exemplary computer environment 40000 for creating, receiving, sending, exchanging, updating, and processing data in accordance with an embodiment of the present invention.

In the depicted embodiment, computer environment 40000 includes, inter alia, AR data system 41000, network 42000, connections 43000, and at least one computing device 44000, such as computing devices smart device 44100, mobile smartphone 44200, and tablet computer 44300. The data system 41000 may comprise an AR apparatus 41100 for use in an AR platform, possibly with its own integrated media server and/or service, or connectable to a third-party media server and/or system 45000 for media content, such as for a production. The network 42000 may connect to an AR media system 45000 that accesses an AR console media account 45100 for the transfer of AR console media account data 45110. Computing devices 44100, 44200, and 44300 are connected to network 42000 via connections 43000, which may be any form of network connection known in the art or yet to be invented. Connections 43000 may include, but are not limited to, telephone lines (e.g., xDSL, T1, leased lines, etc.), cable lines, power lines, wireless transmissions, and the like. Computing devices 44100, 44200, and 44300 include any equipment necessary (e.g., modems, routers, etc.), as is known in the art, to facilitate such communication with the network 42000. AR data system 41000 also may be connected to network 42000 using one of the aforementioned methods or other such methods known in the art.

Using an apparatus and a system such as at depicted in FIGS. 1, 4-5, a user may access the computer environment 40000 via a computing device connected to network 42000 such as computing device 44000. Computing device 44000 may include an auxiliary processing unit (“APU”) 33010, which may function as an intermediate computing device for use between AR apparatus 41100 and AR data system 41000. Such a computing device may be, for instance, a commercial embodiment of APU 33010, or alternatively an individual's personal computer, an Internet café computer, an Apple iPod™, a computerized portable electronic device (e.g., a personal data assistant, cell phone, etc.), or the like. For example, a smartphone may act as an APU 33010 serving as a communications bridge to a tablet computer by providing a “hotspot” to allow the tablet to use the network connectivity of the smartphone to connect to a server.

Using the apparatus and system exemplified in FIGS. 1 and 4-5, such user access may include a download of data to, and/or an upload of data (e.g., an electronic form of information) from, a computing device 44100, 44200, and 44300 via network 42000 to AR data system 41000 (e.g., server, mainframe, computer, etc.), wherein AR data system 41000 is typically provided and/or managed by the entity implementing the process or its affiliate, subcontractor, or the like.

Although the systems and methods disclosed herein have focused on embodiments in which user access initiates the process, one of skill in the art may easily appreciate that such systems and methods may be equally applied for other scenarios in which the process is not initiated by the user, and in which the process proceeds under the control of the AR data system 41000, which may initiate the AR experience in accordance with settings or parameters, such as upon the commencement of an event, such as a concert, a production, a play, etc. For example, AR data system 41000 may push content to a user upon the user arriving at or connecting from a specified location, in which the content is associated with the specified location, or with a topic or a subject matter relevant to the specified location.

Referring to FIG. 5, FIG. 5 shows a block diagram of an exemplary data system for use with systems and methods in accordance with an exemplary embodiment of the present invention, according to aspects of the invention. In addition, FIG. 5 shows an exemplary set of databases, libraries, or data tables for use with the exemplary computer environment, in accordance with the exemplary embodiment of the present invention, according to aspects of the invention. FIG. 5 depicted herein represents an exemplary computing system environment for allowing a user of system 50000 to perform the methods described with respect to FIGS. 1-4.

The depicted computing system environment is only one example of a suitable computing environment and is not intended to suggest any limitation as to the scope of use or functionality. Apart from a customized AR apparatus 51010, numerous other general-purpose or special-purpose computing devices, system environments or configurations may be used, within appropriate application-specific customizations. Examples of well-known computing systems, environments, and/or configurations that may be suitable for use include, but are not limited to, personal computers (“PCs”), server computers, handheld or laptop devices, multi-processor systems, microprocessor-based systems, network PCs, minicomputers, mainframe computers, cell phones, smartphones, tablets, embedded systems, distributed computing environments that include any of the above systems or devices, and the like.

Computer-executable instructions such as program modules executed by a computer may be used. Generally, program modules include routines, programs, objects, components, data structures, etc., that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

FIG. 5 depicts an exemplary system 50000 for implementing embodiments of the present invention. This exemplary system includes, inter alia, one or more computing devices 51000, a network 52000, and at least one server 53000, which interface to each other via network 52000. A computing device 51000 may include an AR console 32000 of an AR apparatus 51010, an auxiliary processing unit 33010 of an apparatus 51010, and/or an AR apparatus 51010 having an auxiliary processing unit 33010 connected to the AR console 32000, such as described in the embodiments of FIGS. 1-3. In its most basic configuration, computing device 51000 includes at least one processing unit, processor 51100, and at least one memory unit 51200. Depending on the exact configuration and type of the computing device, memory 51200 may be volatile (such as random-access memory (“RAM”)), non-volatile (such as read-only memory (“ROM”), solid state drive (“SSD”), flash memory, etc.), or some combination of the two. A basic configuration is illustrated in FIG. 5 by non-volatile memory 51300. In addition to that described herein, computing devices 51000 can be any web-enabled handheld device (e.g., cell phone, smart phone, or the like) or personal computer including those operating via Android, Apple, and/or Windows mobile or non-mobile operating systems.

Computing device 51000 may have additional features and/or functionality. For example, computing device 51000 may include additional storage (removable and/or non-removable) including, but not limited to, magnetic or optical disks or tape, thumb drives, and external hard drives as applicable. Such additional storage is illustrated in FIG. 5 by removable storage 51400 and non-removable storage 51500.

Computing device 51000 typically includes or is provided with a variety of computer-readable media. Computer-readable media can be any available media that can be accessed by computing device 51000 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 51200, removable storage 51400, and non-removable storage 51500 are all examples of computer storage media. Computer storage media includes, but is not limited to, RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, or any other medium that can be used to store the desired information, and that can accessed by computing device 51000. Any such computer storage media may be part of computing device 51000 as applicable.

Computing device 51000 may also contain a communications connection 51600 that allows the device to communicate with other devices. Such communications connection 51600 is an example of communication media. Communication media typically embodies computer-readable instructions, data structures, program modules and/or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (“RF”), infrared and other wireless media. The term computer-readable media as used herein includes both storage media and communication media.

Computing device 51000 may also have input device(s) 51700 such as keyboard, mouse, pen, camera, light sensor, motion senor, infrared (“IR”) sensor, accelerometer, inertia motion unit (“IMU”), voice input device, touch input device, etc. Output device(s) 51800 such as a display, speakers, LED light, printer, etc. may also be included. Some input devices 51700 may be considered output devices 51800 for other components, such as a camera providing a video feed, or a sensor providing data on the activity that is sensed. All these devices are generally known to the relevant persons of skill in the art and therefore need not be discussed in any detail herein except as provided.

Notably, computing device 51000 may be one of a plurality of computing devices 51000 inter-connected by a network 52000. As may be appreciated, network 52000 may be any appropriate network and each computing device 51000 may be connected thereto by way of connection 51600 in any appropriate manner. In some instances, each computing device 51000 may communicate with only the server 53000, while in other instances, computing device 51000 may communicate with one or more of the other computing devices 51000 in network 52000 in any appropriate manner. For example, network 52000 may be a wired network, wireless network, or a combination thereof within an organization or home, or the like, and may include a direct or indirect coupling to an external network such as the Internet or the like. Likewise, the network 52000 may be such an external network.

Computing device 51000 may connect to a server 53000 via such an internal or external network. Server 53000 may serve, for instance, as an AR platform, a media server, service, or platform, or both. Although FIG. 5 depicts computing device 51000 located in close proximity to server 53000, this depiction is not intended to define any geographic boundaries. For example, when network 52000 is the Internet, computing device can have any accessible physical location. For example, computing device may be a tablet, cell phone, smartphone, personal computer, or the like located at any user's office, home, or other venue, etc. Or computing device could be located proximate to server 53000 without departing from the scope hereof. Also, although FIG. 5 depicts computing devices 51000 coupled to server 53000 via network 52000, computing devices may be coupled to server 53000 via any other compatible networks including, without limitation, an intranet, local area network, or the like.

The system may use a standard client-server technology architecture, which allows users of the system to access information stored in the relational databases via custom user interfaces. An application may be hosted on a server such as server 53000, which may be accessible via the Internet, using a publicly addressable Uniform Resource Locator (“URL”). For example, users can access the system using any web-enabled device equipped with a web browser. Communication between software component and sub-systems are achieved by a combination of direct function calls, publish and subscribe mechanisms, stored procedures, and direct SQL queries.

In some embodiments, for instance, server 53000 may be provided as a service, such as via Amazon Web Services (“AWS”), or as a dedicated stand-alone service, such as an Edge R200 server as manufactured by Dell, Inc., however, alternate servers may be substituted without departing from the scope hereof. System 50000 and/or server 53000 utilize a PHP scripting language to implement the processes described in detail herein. However, alternate scripting languages may be utilized without departing from the scope hereof.

An exemplary embodiment of the present invention may utilize, for instance, a Linux variant messaging subsystem. However, alternate messaging subsystems may be substituted including, without limitation, a Windows Communication Foundation (“WCF”) messaging subsystem of a Microsoft Windows operating system utilizing a .NET Framework 3.0 programming interface.

Also, in the depicted embodiment, computing device 51000 may interact with server 53000 via a Transmission Control Protocol/Internet Protocol (“TCP/IP”) communications protocol; however, other communication protocols may be substituted.

Computing devices 51000 may be equipped with one or more Web browsers to allow them to interact with server 53000 via a HyperText Transfer Protocol (“HTTP”) and/or a secure version (e.g., “https”) of a related Uniform Resource Locator (“URL”). HTTP functions as a request-response protocol in client-server computing. For example, a web browser operating on computing device 51000 may execute a client application that allows it to interact with applications executed by server 53000. The client application submits HTTP request messages to the server. Server 53000, which provides resources such as HTML files and other content, or performs other functions on behalf of the client application, returns a response message to the client application upon request. The response typically contains completion status information about the request as well as the requested content. However, alternate methods of computing device/server communications may be substituted without departing from the scope hereof.

In the exemplary system 50000, server 53000 includes one or more databases 54000 as depicted in FIG. 5, which may include a plurality of libraries or database tables including, without limitation, Templates, Users, Events, Memories, Moments, Maps, Utilities, User Uploads, Admin Info, Transactions, Status, Tracking, and/or Location database tables, e.g., 54100 through 54600. As may be appreciated, database(s) 54000 may be any appropriate database capable of storing data and it may be included within or connected to server 53000 or any plurality of servers similar to 53000 in any appropriate manner.

In the exemplary embodiment of the present invention depicted in FIG. 5, database(s) 54000 may be structured query language (“SQL”) database(s) with a relational database management system, namely, MySQL as is commonly known and used in the art. Database(s) 54000 may be resident within server 53000. However, other databases may be substituted without departing from the scope of the present invention including, but not limited to, PostgreSQL, Microsoft® SQL Server 2008 MySQL, Microsoft® Access®, and Oracle databases, and such databases may be internal or external to server 53000.

The various techniques described herein may be implemented in connection with hardware or software or, as appropriate, with a combination of both. Thus, the methods and apparatus of the presently disclosed subject matter, or certain aspects or portions thereof, may take the form of program code (i.e., instructions, scripts, and the like) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter.

In the case of program code execution on programmable computers, the interface unit generally includes a processor, a storage medium readable by the processor (including volatile and non-volatile memory and/or storage elements), at least one input device, and at least one output device. One or more programs may implement or utilize the processes described in connection with the presently disclosed subject matter (e.g., through the use of an application programming interface (“API”), reusable controls, or the like). Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as a system 50000 or a distributed computing environment 40000. Still further, aspects of the presently disclosed subject matter may be implemented in or across a plurality of processing chips or devices, and storage similarly may be created across a plurality of devices in system 50000. Such devices might include personal computers, network servers, and handheld devices (e.g., cell phones, tablets, smartphones, etc.), for example.

In the exemplary embodiment, server 53000 and its associated databases are programmed to execute a plurality of processes including those shown in FIGS. 1-3 as discussed in greater detail herein.

Methods in accordance with aspects of the invention include, for instance, a method for interactive communication adapted for entertainment and/or education of a participant, wherein the method comprises providing an apparatus adapted for interaction with the participant, such as apparatus 10000; configuring the apparatus to interact with the participant; enabling the apparatus to interact with the participant; and capturing electronically in the apparatus audio data, video data, or both, of an interaction of the apparatus with the participant. Further embodiments of the method may include performing the actions associated the functionalities set forth in FIGS. 1-5, such as within the AR console apparatus 10000, within the computing environment 40000, and within the system 50000.

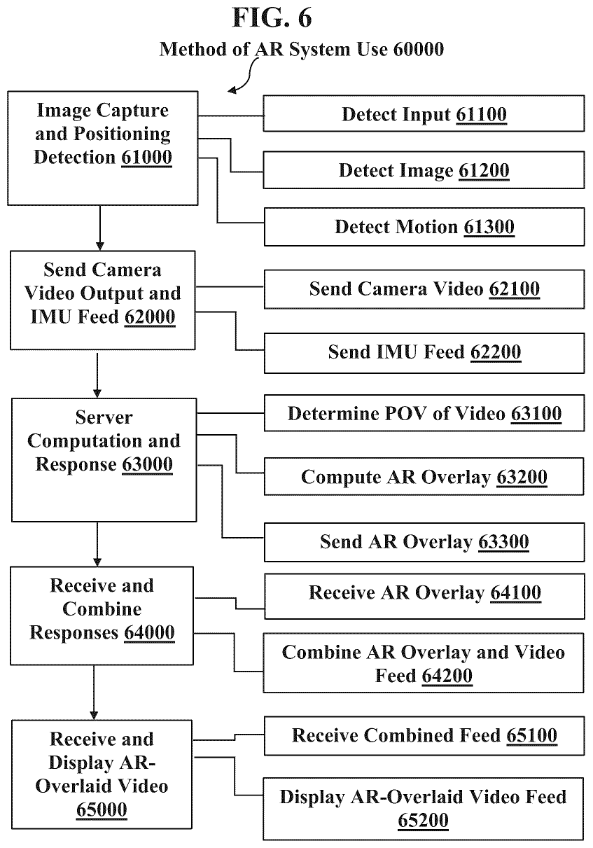

Referring to FIG. 6, FIG. 6 shows a block diagram of an exemplary embodiment of a method 60000 of use of an exemplary AR system, according to aspects of the invention. In the method 60000 as depicted in FIG. 6, the AR system may perform a step 61000 of image capture and positioning detection at the apparatus. The image capture and positioning detection step 61000 may include, for instance, detecting 61100 an input, such as a button press to activate the apparatus; detecting 61200 an image captured by a camera of the apparatus, such as in which the image is detected during a concert or performance, and possibly using machine vision or AI to identify the location by structures in the background; and detecting motion 61300, such as to generate positioning data and/or to indicate that the apparatus is being moved or handled by a user. The AR system may perform a step 62000 at the apparatus of transmission of camera video output and accelerometer or IMU feed from the console to a server, such as via an auxiliary processor unit. This transmission step 62000 may include sending 62100 the camera video from the camera to the server, possibly via the auxiliary processor unit, for combination with an AR overlay, and sending 62200 the IMU feed from the auxiliary processor unit to the server, for positioning calculations and determinations of the appropriate AR overlay. The AR system may perform a step 63000 at the server of server computation and response to the transmission step 62000. This computation and response step 63000 may include determining 63100 a point of view (POV) of the camera video, computing 63200 an AR overlay appropriate to the camera position and POV, and sending 63300 the AR overlay to the apparatus. The AR system may perform a step 64000 at the apparatus of receipt and combination of responses from the server. The receipt and combination of responses step 64000 may include receiving 64100 the AR overlay and combing 64200 the AR overlay and the video feed. The AR system may perform the step 65000 at the apparatus of receipt and display of the AR-overlaid video. The receipt and display of AR-overlaid video step 65000 may include receiving 65100 the combined feed comprising the AR-overlaid video, and displaying 65200 the AR-overlaid video feed on the micro-displays of the console.

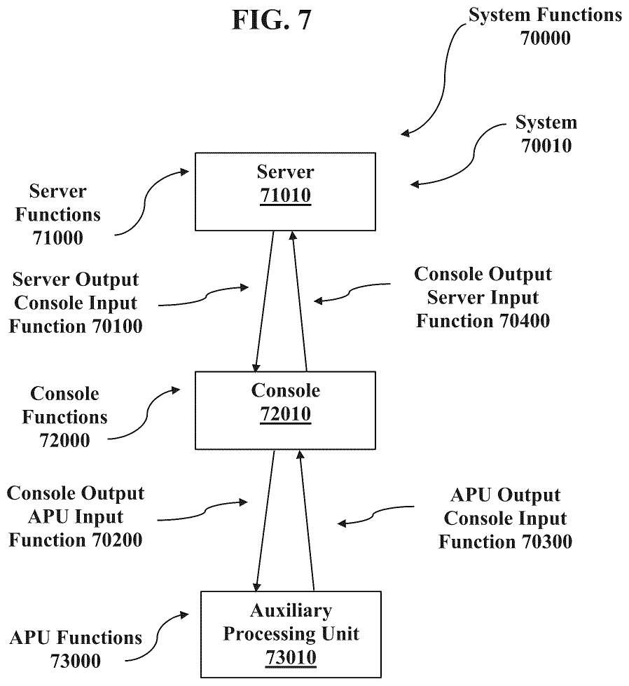

Referring to FIG. 7, FIG. 7 shows a conceptual block diagram of an exemplary system functions 70000 operation flow within a system 70010 and with methods in accordance with an exemplary embodiment of the present invention, according to aspects of the invention. The embodiment of FIG. 7 depicts an exemplary commercial embodiment of the Lifecache® system and is not limiting of the invention overall. The depicted system functions 70000 conceptually may be divided into the server functions 71000 of server 71010, console functions 72000 of console 72010, and auxiliary processing unit functions 73000 of auxiliary processing unit (“APU”) 73010. The system functions 70000 conceptually may be divided into the server output, console input functions 70100, the console output, APU input functions 70200, the APU output, console input functions 70300, and the console output, server input functions 70400. In this depicted embodiment, the APU 73010 might be a separate camera, such as a 360-degree-capture camera, that communicates with a console 72010 that may be a smartphone running an app that communicates with the server 71010. In some embodiments, an APU output, console input function 70400 may arise (e.g., a data transfer by a user moving a storage device), but the embodiment might lack a console output, APU input function 70200, because the console 72010 might not directly control, operate, or communicate with the APU 73010 (such as where the user separately controls each of the console 72010 and the APU 73010).

At a high conceptual level, a data flow may be represented by the server output, console input functions 70100, the console output, APU input functions 70200, the APU output, console input functions 70300, and the console output, server input functions 70400. For example, the server 71010 may connect to the console 72010 using the server output, console input functions 70100 to push location-based data to the console 72010. The console 72010 may then communicate some of the location-based data to the APU 73010 to initiate image capture by the APU 73010, using the console output, APU input functions 70200. The APU 73010 may send image data back to the console 72010, using APU output, console input functions 70300, for the image data to be overlaid with AR content received from the server 71010. The console 72010 may transfer some image data to the server 71010 using the console output, server input functions 70400. For example, the APU output, console input functions 70300 might comprise the APU 73010 generating 360-degree video data that are transferred to the console 72010. The console 72010 might generate positioning data from positioning sensors and transfer the video data to the server 71010 as a console output, server input function 70400. As a server function 71000, the server 71010 may use the positioning data to generate an augmented reality overlay appropriate to the positioning data and timing of the positioning data relative to the events in the video data, and sending the AR overlay to the console 72010. As a console function 72000, the console 72010 may combine the AR overlay with the video data to create and display an AR-overlaid video data feed, and possibly sending the AR-overlaid video data feed to the APU 73010 if the APU 73010 is a HMD. If the APU 73010 is a HMD, an APU function 73000 includes displaying the AR-overlaid video data. If the console 72010 includes a display, the console functions 72000 may include displaying the AR-overlaid video data on the display of the console for viewing by a user.

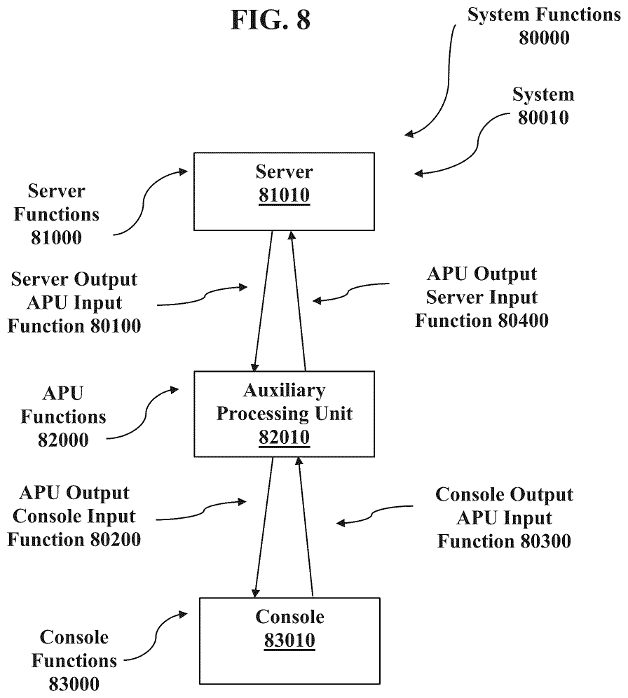

Referring to FIG. 8, FIG. 8 shows a conceptual block diagram of an exemplary system functions 80000 operation flow within a system 80010 and with methods in accordance with an exemplary embodiment of the present invention, according to aspects of the invention. The embodiment of FIG. 8 depicts an exemplary commercial embodiment of the Lifecache® system and is not limiting of the invention overall. The depicted system functions 80000 conceptually may be divided into the server functions 81000 of server 81010, auxiliary processing unit functions 82000 of auxiliary processing unit (“APU”) 82010, and console functions 83000 of console 83010. The system functions 80000 conceptually may be divided into the server output, APU input functions 80100, the APU output, console input functions 80200, the console output, APU input functions 80300, and the APU output, server input functions 80400. In this depicted embodiment, the APU 82010 might be a separate computing device, such as a tablet, laptop, or desktop computer, or an intermediate buffering server, that communicates with a console 83010 that may be a smartphone running an app that communicates with the server 81010 via, at least in part, the APU 82010. In other embodiments, the console 83010 might comprise a front-facing camera on a pair of AR glasses or an HMD, in which the AR glasses or HMD displays video content, and the APU 82010 might be a smartphone running the Lifecache® app that serves as a data processor for the console 83010 and data bridge with the server 81010.

At a high conceptual level, a data flow may be represented by the server output, APU input functions 80100, the APU output, console input functions 80200, the console output, APU input functions 80300, and the APU output, server input functions 80400. For example, the server 81010 may connect to the APU 82010 using the server output, APU input functions 80100 to push location-based data to the APU 82010. The APU 82010 may then communicate some of the location-based data to the console 83010 to initiate image capture by the console 83010, using the APU output, console input functions 80200. The console 83010 may send image data back to the APU 82010, using console output, APU input functions 80300, for the image data to be overlaid with AR content received from the server 81010. The APU 82010 may transfer some image data to the server 81010 using the APU output, server input functions 80400. For example, the console output, APU input functions 80300 might comprise the console 83010 generating 2D video data that are transferred to the APU 82010. The console 83010 also might generate positioning data from positioning sensors. The APU 82010 might transfer the video data to the server 81010 as an APU output, server input function 80400. As a server function 81000, the server 81010 may use the positioning data to generate an augmented reality overlay appropriate to the positioning data and timing of the positioning data relative to the events in the video data, and the server 81010 may send the AR overlay to the APU 82010 for display on the console 83010. As an APU function 82000, the APU 82010 may combine the AR overlay with the video data to create an AR-overlaid video data feed sent to the console 83010. As a console function 83000, the console 83010 may display the AR-overlaid video data feed. If the APU 82010 includes a display as well, the APU functions 82000 may include displaying the AR-overlaid video data on the display of the APU also, such as for monitoring what a user is viewing on the console 83010.

As presented differently, the console functions 83000 may comprise the console 83010 generating video data using a front facing camera of a reality, as viewed from a viewer's perspective, who is holding the camera to the viewer's face, generating positioning data from the console 83010, and sending the live video data and the positioning data to the auxiliary processing unit 82010. The auxiliary processing unit functions 82000 may include the APU 82010 receiving the live video and the positioning data from the console 83010 and communicating with the server 81010 to have the server 81010 perform the server functions 81000 comprising generating digital content that includes an augmented reality overlay appropriate to the positioning data and timing of the positioning data relative to the events in the video data, and sending the digital content from the server 81010 to the APU 82010. The auxiliary processing unit functions 82000 further include the APU 82010 combining aspects of the digital content as the AR overlay with the live video to create an augmented video data feed, and sending the augmented video data feed to the console 83010. The console functions 83000 include the console 83010 displaying the augmented video data on the display(s) of the console 83010 for viewing by a user to create an augmented reality experience.

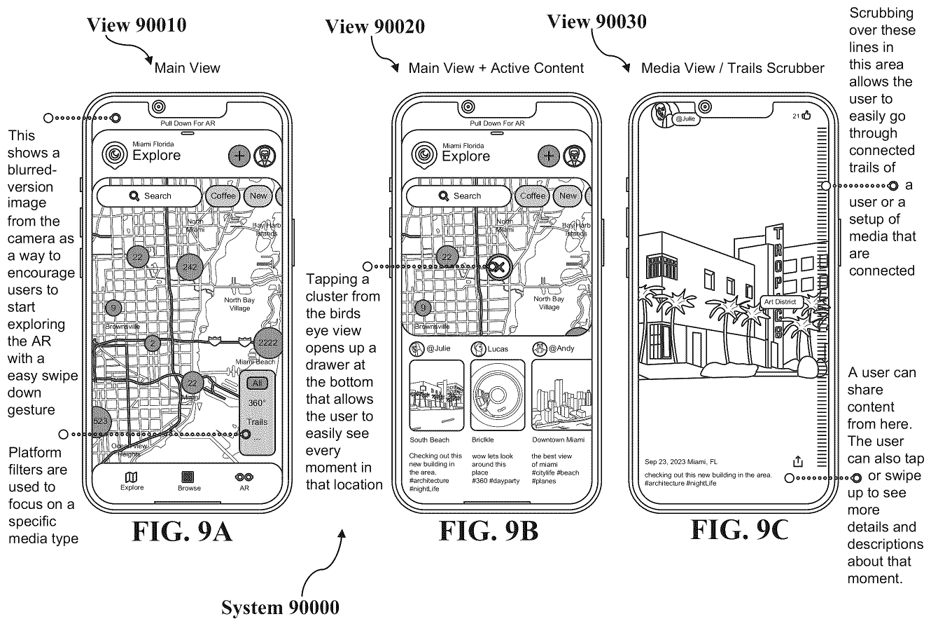

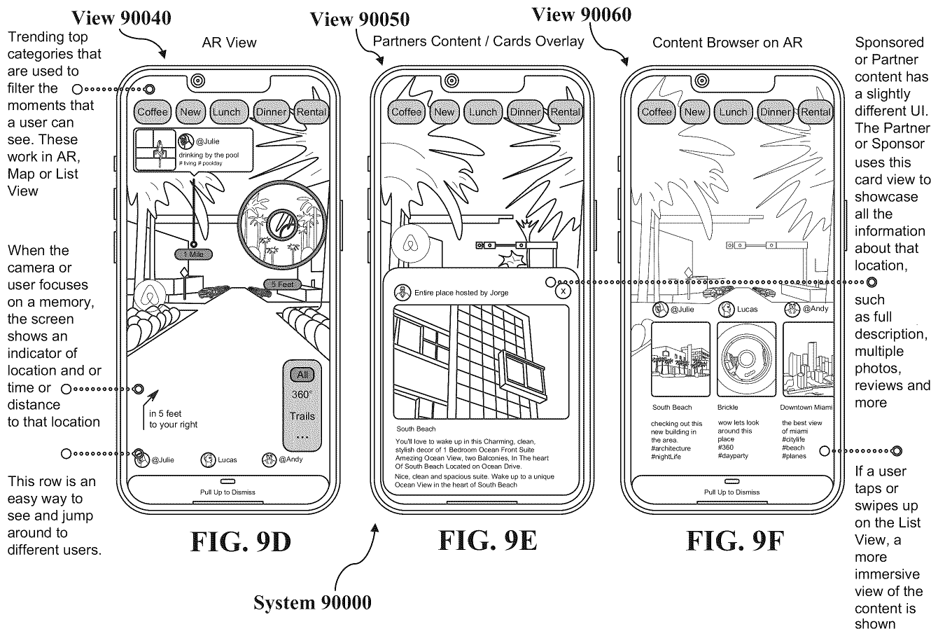

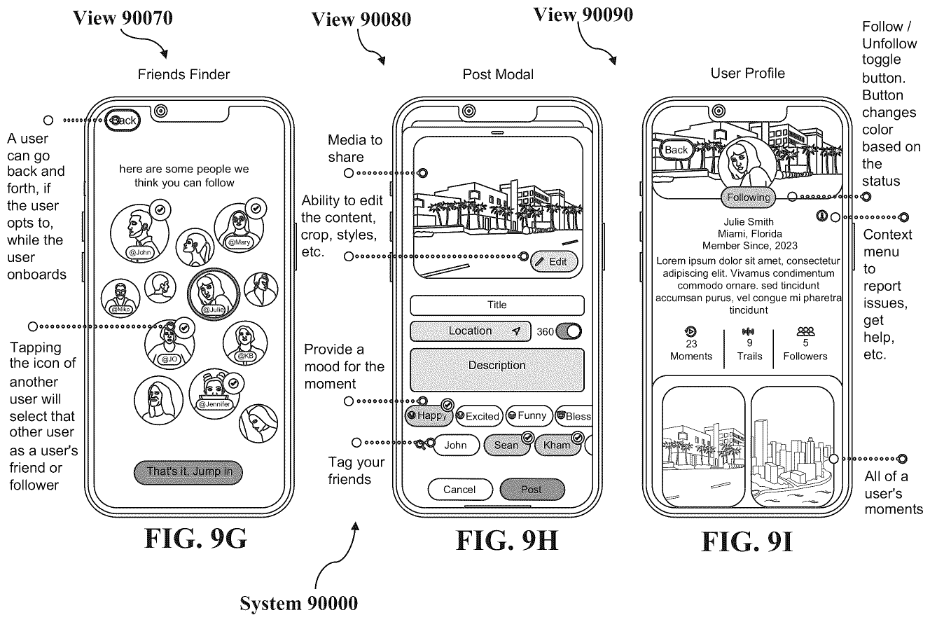

Referring to FIGS. 9A-9I, FIGS. 9A-9I show various views 90010, 90020, 90030, 90040, 90050, 90060, 90070, 90080, 90090 of screenshots of a graphical user interface (“GUI”) of an exemplary apparatus operation, such as that of a smartphone, as an apparatus within a system 90000 used pursuant to a method in accordance with an exemplary embodiment of the present invention, according to aspects of the invention. The embodiment of system 90000 shown in FIGS. 9A-9I shows an exemplary commercial embodiment of the Lifecache® system and is not limiting of the invention overall. The system 90000 depicts in FIG. 9A a view 90010 comprising a Main View, in FIG. 9B a view 90020 comprising a Main View+Active Content, in FIG. 9C a view 90030 comprising a Media View/Trails Scrubber, in FIG. 9D a view 90040 comprising an AR View, in FIG. 9E a view 90050 comprising Partners Content/Cards Overlay, in FIG. 9F a view 90060 comprising Content Browser on AR, in FIG. 9G a view 90070 comprising a Friends Finder, in FIG. 9H a view 90080 comprising a Post Modal, and in FIG. 9I a view 90090 comprising a User Profile.

As shown in FIG. 9A, view 90010 comprises a Main View that shows an “Explore” screen for a location (e.g., Miami, Florida), and a map of the location, with the user's profile circular image in the upper-right corner. A screen instruction at the top may prompt a user to “Pull Down For AR” to change what the GUI shows. A blurred version of the image from the camera may be shown in the background, and it's a way to encourage users to start exploring the AR with an easy swipe-down gesture. The map depicts circular dots with numbers of content at each dot location, each dot combining content referred to as a Cluster. Platform filters may be set to focus on a specific media type to be counted in the Clusters represented by the dots.

As shown in FIG. 9B, view 90020 comprises a Main View+Active Content that shows a variation of the “Explore” screen for a location (e.g., Miami, Florida), and a smaller map of the location, with the user's profile circular image in the upper-right corner. The screen instruction at the top may prompt a user to “Pull Down For AR” to change what the GUI shows. Tapping a Cluster from the birds' eye view opens up a drawer at the bottom that allows the user to easily see every Moment in that location. Each Moment depicts the circular image of the user posting the Moment above an image sampled for the Moment and a brief text sampled for the Moment.

As shown in FIG. 9C, view 90030 comprises a Media View/Trails Scrubber that shows an image screen for a location (e.g., the Tropics building in Miami, Florida), a location tag (e.g., “Art District”), and a date and name of the location at the bottom (e.g., “Nov. 22, 2021 Miami, FL”), along with a brief text (e.g., “checking out this new building in the area #architecture #nightlife”), with the posting user's profile circular image in the upper-left top corner. Lines on the right vertical side of the GUI guide the user in scrubbing the image and related content. Scrubbing over this lines' area allows the user to easily go through a connected set of trails of a user or a setup of media that are connected. The GUI may inform the user, “You can share content from here.” The user can also tap/swipe up to see more details and descriptions about that Moment.

As shown in FIG. 9D, view 90040 comprises an AR View for a location (e.g., Miami, Florida), and menu filters for the location (e.g., “Coffee,” “New, “Launch,” “Dinner,” “Rental,” etc.). The filters may include top categories that users use to filter the Moments that the user can see. These filters may work in the AR, Map, or List View. When the camera and the user focus on a Memory, they get an indicator of the location and/or time or distance to that location (e.g., a bent arrow and the text, “in 5 feet to your right”). At the bottom of the screen may be a row of posting user profile circular images to indicate users who have posted near that location. This row is an easy way to see and jump around to different users.

As shown in FIG. 9E, view 90050 comprises a Partners' Content/Cards Overlay view that shows a split screen for the location. The Overlay of Partners' Content or Cards is depicted as a pop-up frame over the background image of the location. The Overlay may indicate the posting user and user profile circular image who posted the content (e.g., “Entire place hosted by Jorge”), with an image and descriptive text (e.g., “South Beach—You'll love to wake up in this charming, clean, stylish décor of 1 bedroom ocean front suite. Amazing ocean view; two balconies; in the heart of South Beach located on Ocean Drive.”). Sponsored or Partner Content may have a slightly different UI. The view 90040 uses this Card View to showcase all the information about that location, such as full description, multiple photos, reviews, and more.

As shown in FIG. 9F, view 90060 comprises a Content Browser on AR view that shows a split screen for the location. The AR content is depicted as overlaid frames over a blurred image of the location in the background. The overlaid AR content may indicate the posting user and user profile circular image who posted the content (e.g., “@Julie”), with an image and descriptive text (e.g., “South Beach—checking out this new building in the area #architecture #nightlife”). If a user taps or swipes up on the List view, the user gets a more immersive view of the content. A screen tip at the bottom may instruct the user to “Pull Up To Dismiss” the list view of the AR content.

As shown in FIG. 9G, view 90070 comprises a Friends Finder view that shows a screen of user profile circular images with the instruction “here are some people we think that you can follow” above the images. The Friends Finder view allows a user to view proposed “friends” among other users to “follow” the selected other users. Users can go back and forth between screen views if they choose to while they onboard new friends. Tapping other users' profile images will select those other users as your friends or followers. The screen may prompt the user “That's it, Jump in” at the bottom of the screen to navigate the user to an immersive view after selecting new friends or new followings.

As shown in FIG. 9H, view 90080 comprises a Post Modal view that shows a screen of content and content-related fields for a user to post media and create a Moment. The Post Modal view allows a user to select and describe media to be posted and to select proposed friends among other users to tag the selected other users. The screen view displays the media to share, with an ability to edit the content, such as crop, styles, etc. Content fields allow a user to enter a Title, a Location, and a Description, to indicate if the content is 360-degree content, to provide a mood for the Moment (e.g., “Happy,” “Excited,” “Funny,” “Bless”), to tag your friends (e.g., “John,” “Sean,” “Kham”), and to post the content, or to cancel the post.

As shown in FIG. 9I, view 90090 comprises a User Profile view that shows a screen of user profile information and content for another user. The User Profile view may include a circular image of the other user, an indication of whether the user accessing the profile is following the other user, the other user's name (e.g., “Julie Smith”), other user's location (e.g., “Miami, Florida”), other user's user history (e.g., “Member Since 2021”), a brief description of the other user (e.g., “Lorem ipsum dolor sit amet, consectetur adipiscing elit. Vivamus condimentum commodo ornare. Sed tincidunt accumsan purus, vel congue mi pharetra tincidunt.”), and a summary of the other user's activity (e.g., “24 Moments,” “4 Trails,” “2 Followers”). Below the other user's information, thumbnail images may appear of all of the other user's Moments, if any. The indication of “Following” or not may act as a follow/unfollow button, and the button may change color based on the state of following or not following. The Content menu may be used to report issues, get help, etc.

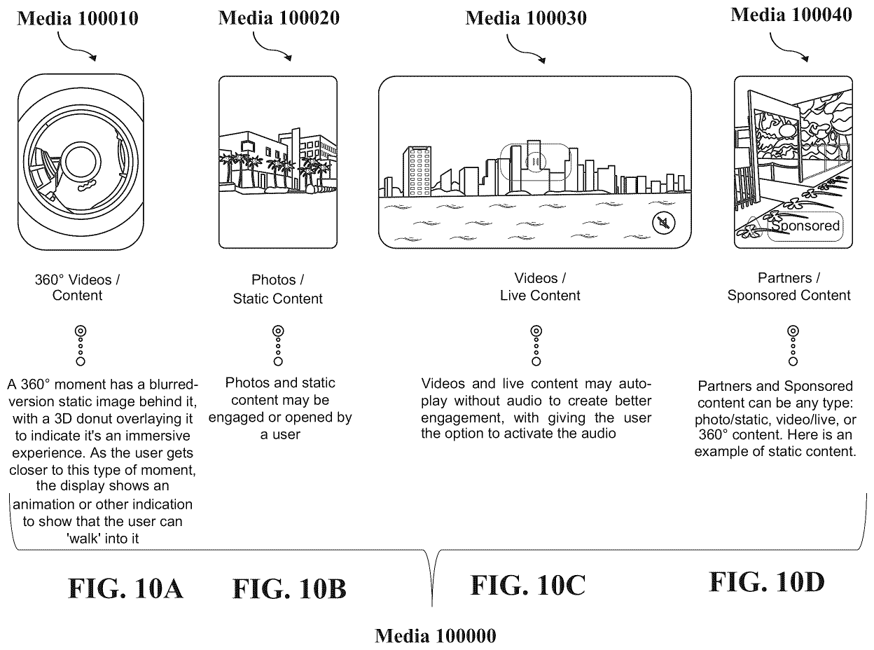

Referring to FIGS. 10A-10D, FIGS. 10A-10D show depictions of various media 100000 and specific media 100010, 100020, 100030, 100040 that may be used in an exemplary apparatus operation, such as that of a smartphone, as an apparatus within a system used pursuant to a method in accordance with an exemplary embodiment of the present invention, according to aspects of the invention. The embodiment of FIGS. 10A-10D show an exemplary commercial embodiment of the Lifecache® system and is not limiting of the invention overall. The depicted media 100000 might be used, for example, in system 90000. Media 100000 may include, for instance, media 100010 in FIG. 10A, comprising 360-degree-capture photos, images, and/or video; media 100020 in FIG. 10B, comprising static photos or images; media 100030 in FIG. 10C, comprising animated or moving images, videos, with or without audio, including “live” broadcasts or “livestream” video; and media 100040 in FIG. 10D, comprising information, data, images, photos, video, audio, and/or other content for partners, sponsors, advertisers, services, public utilities, governments, etc. In FIG. 10A, media 100010 of 360-degree video, for example, may be depicted such that a 360° Moment may have a blurred version static image behind it, with a 3D donut overlaying it to indicate it's an immersive experience. As the user gets closer to these types of Moments, there may be some animation or indication so show that the user can “walk” into such a Moment. In FIG. 10B, media 100020 of a static photo, for example, may be depicted to a user in a way that such photo or static content should be engaged or opened by the user. In FIG. 10C, media 100030 of a video or livestream, for example, may be depicted to a user in a way that such video or live content should auto-play with or without audio to create better engagement. In FIG. 10D, media 100040 of partners or sponsored content, for example, may be depicted to a user in a way that such partners or sponsored content can be any type (e.g., photo, static image, video, livestream, or 360-degree content), with the depicted image being an example of just a static image content.

The system 90000 of FIGS. 9A-9I and media 100000 of FIGS. 10A-10D may comprise components of an exemplary embodiment commercialized under the trademark Lifecache™ for an AR social media platform. The Lifecache™ platform unlocks the potential of 360-degree content by enabling users to consume immersive 360-degree content in a location-based Augmented Reality end-to-end experience. The end-to-end experience described may include mobile devices, a secure web portal, and headset technology. This end-to-end solution enables the management and distribution of 360° immersive media experiences such as AR/VR/MR technologies. Through this process, users will be able to benefit from the lifecache techniques and technology provided to enhance immersive content experiences.

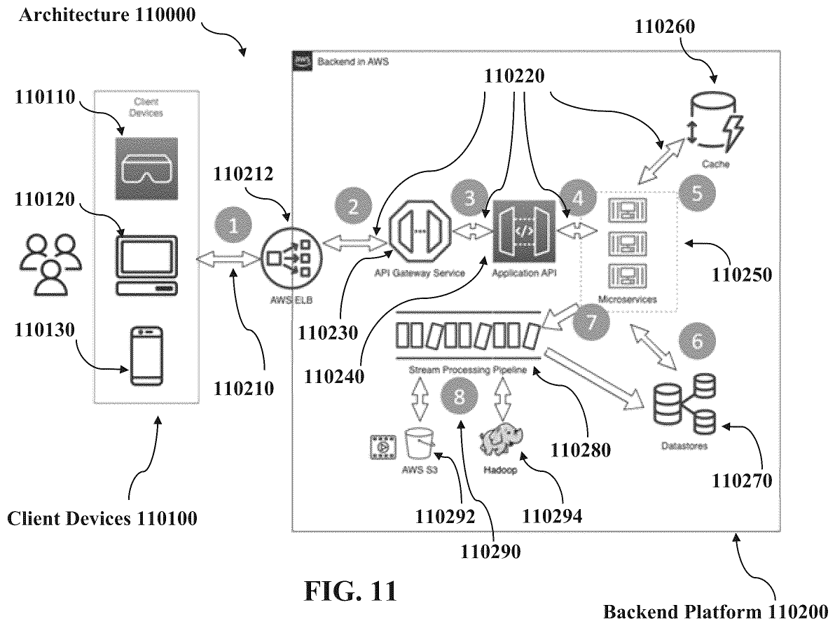

Referring to FIG. 11, FIG. 11 shows a block diagram of an exemplary architecture 110000 of exemplary components of an exemplary system, and an exemplary set of databases for use within the exemplary computer environment, for use with systems and methods in accordance with an exemplary embodiment of the present invention, according to aspects of the invention. The architecture 110000 may be conceptualized as split between client devices 110100 and a backend platform 110200. The client devices may include, for instance, a headset 110110, a personal computer 110120, and a mobile handheld device or smartphone 110130. The backend platform 110200 may include, for example, one or more instances of a network data connection 110210 to the client devices 110100, which may include data being routed through an Amazon® Web Services (“AWS”) Elastic Load Balancer (“ELB”) 110212. The backend platform 110200 may include several data connections 110220, such as from AWS® ELB 110212 to an API Gateway Service 110230, to an Application API 110240, to Microservices Server Array 110250, a Data Cache 110260, a Datastore 110270, a Stream Processing Pipeline 110280, and a Storage Solution 110290, such as an AWS® Simple Storage Service (“S3”) 110292 and an Apache® Hadoop® Distributed File System (“DFS”) 110294 as a data framework that is used to efficiently store and process large datasets.

The backend platform 110200 may provide several microservices at the Microservices Server Array 110250, with the microservices pertaining to one or more functional aspects of the Lifecache® backend platform 110200, which functionally may be split into major data functionality components that are independent and comprise Users, MomentReads, MomentWrites, TrailReads, and TrailWrites. The concepts of Users, Moments, and Trails are explained in greater detail hereafter. The Users functionality may be adapted to read and write user info as a very quick operation, because the function will often require single database changes or gets, potentially permitting all user functionality to be put into one service. The Moments functionality may be adapted to allow Moments to be read fast and by millions of people, while the Moment writes can be slower. At scale, processing time of Moment reads will always be a multiple of that of writes. For example, the average YouTube® video will get 8332 views, but be written only once, initially. This processing time distinction between Moment reads and Moment writes may motivate the splitting of services for Moment reads and Moment uploads. The Trails functionality has some similarity to that of Moments, as most users will explore Trails in batches, and the system may be adapted and/or configured to enable many more reads than writes, which likewise may prompt the split into separate services to read and write.

Each microservice may be scaled separately, which may allow the system to provide high availability, low latency on video streaming, and high reliability on video uploads. Each service may be channeled through multiple availability zones, and requests may go through a load balancer, to help prevent any single point of failure for all services to be online. Each service may be containerized by creating docker images, and the system may employ Elastic Common Scheme (“ECS”) clusters to deploy the services. A load balancer may be added to the ECS cluster to evenly distribute requests that may be sent to one or more instance of an AWS Fargate®. AWS Fargate® is a technology that may be used with Amazon® ECS to run containers without having to manage servers or clusters of Amazon® EC2 instances. With AWS Fargate®, the system need not provision, configure, or scale clusters of virtual machines to run containers, removing the need to choose server types, to decide when to scale system clusters, or to optimize cluster packing.

The Moment Uploads functionality for uploading and writing Moments may leverage AWS S3 to enable a multipart upload feature to efficiently chunk data and process data in parallel. For example, the client device 110100 may break up a video into data chunks and send the data chunks to the upload service, which will initiate multipart uploads to AWS S3. For each new moment being created, a pre-signed URL may be requested from S3 and stored in a system database. This URL may then be used to add chunks to an S3 file location. Each chunk may be compressed as the backend is relaying the chunk to S3. The chunked data may be processed through an event stream to enable and/or provide real-time updates.

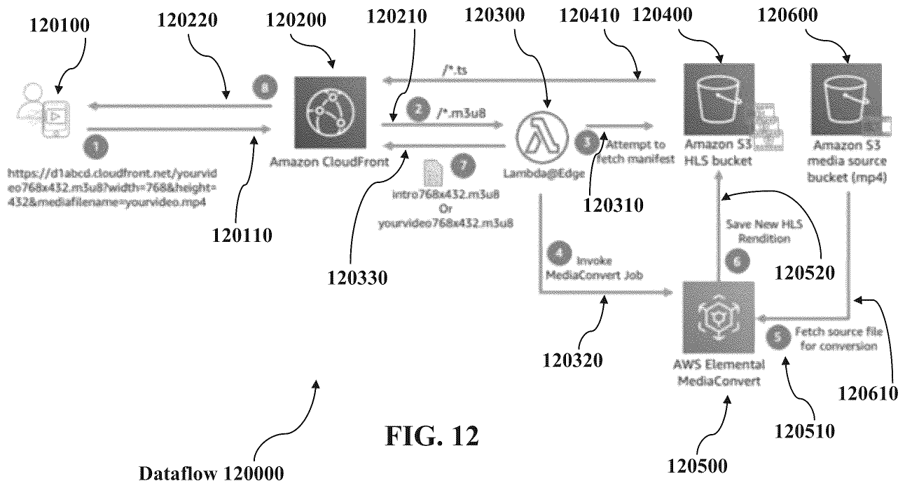

Referring to FIG. 12, FIG. 12 shows a block diagram of an exemplary dataflow 120000 of an exemplary system, and an exemplary set of databases for use within the exemplary computer environment, for use with systems and methods in accordance with an exemplary embodiment of the present invention, according to aspects of the invention. FIG. 12 depicts an exemplary dataflow 120000 of a request for and provision of Video Streaming. For example, a user with a client device 120100 may submit 120110 a request to an Amazon® CloudFront® service 120200, which may send 120210 a request to a Lambda@Edge™ service 120300. The Lambda@Edge service 120300 may send 120310 a command to fetch a manifest from an Amazon® S3 HTTP Live Streaming (“HLS”) bucket 120400 and may send 120320 an invoke MediaConvert Job command to an AWS Elemental MediaConvert™ service 120500, which in turn may fetch 120510 a source file (e.g., in mp4 format) for conversion from an Amazon® S3 media source bucket 120600 that may send 120610 the file to the AWS Elemental MediaConvert™ service 120500. The AWS Elemental MediaConvert™ service 120500 in turn may convert the file and save 120520 at the Amazon® S3 HLS bucket 120400 a new HLD Rendition of the file for streaming. The Amazon® S3 HLS bucket 120400 may send 120410 streaming video data files (e.g., video transport stream files having video data in /*.ts format) back to the Amazon CloudFront® service 120200. Separately, the Lambda@Edge service 120300 may send 120330 video audio files (e.g., audio playlist files in /*.m3u8 format) back to the Amazon CloudFront® service 120200. The Amazon® CloudFront™ service 120200 then may stream 120220 audio data and video data to the requesting user's client device 120100.

As depicted in FIG. 12, the backend platform (e.g., comprising Amazon® CloudFront® service 120200, Lambda@Edge™ service 120300, Amazon® S3 HLS bucket 120400, AWS Elemental MediaConvert™ service 120500, and Amazon® S3 media source bucket 120600) is in charge of uncompressing and sending appropriate media chunks to the client device 120100. The system may achieve these functions by leveraging the AWS Elemental MediaConvert™ service 120500, which may be adapted and/or configured to convert media files according to the requesting client device 120100 (e.g., an iOS client device 120100 and a headset client device 120100 each will need different media types for streaming). Integral to streaming are the Database and Caching functionalities, and the system may use PostgreSQL to leverage the capabilities of relational databases pertaining to Atomicity, Consistency, Isolation, Durability (“ACID”), to facilitate high reliability on data writes. The database Atomicity, Consistency, Isolation, Durability properties may be adapted and/or configured to reliably process database transactions and to facilitate recovery of a database from any failure that might occur while processing a transaction. Similarly, the system may include a Redis™ caching layer that may be accessible for all reads and may be dirtied on writes.

As explained herein in more detail, the lifecache platform uses various terminology to refer to aspects of the system or interaction, such as AR View, Map View, Trails, Memories, Moments, Clusters, “Do Things Worth Reliving,” “Autobiographies,” “Biography,” “Flashbacks,” “A Day In The Life” Of [John Doe], “A Day In History,” MTVRS, Metavrx, Meta-Moments, and Travelverse, some of which are used as trademarks to refer to products and features of the platform and are not to be construed as generic nomenclature for such products or features.

An exemplary embodiment of the lifecache platform begins on a mobile device with a User Sign-Up process. The user sign up process prompts for the user's name, username, email, and password. The user sign-up process also may pull information from the lifecache user database, such as to check for an existing account under the email address provided. A welcome email is sent once the user is registered and directs the user back to the app to login. The User Login process may then be performed. A user can login to the app in multiple ways, either using an account created with their email ID, or using other 3rd-party API login options such as Facebook (Meta) & Apple. A user can have a one-click sign-in experience by linking the user's other social media to the lifecache account.

Walk Through Screens may facilitate account creation. Walkthrough screens are the initial screens a first-time user sees after launching the app. These screens may be customizable with any number of screens and images. The ability to customize is enabled by the lifecache engine, which leverages technology APIs to create an interactive walk-through experience.

Depicted in the visuals of views 90010-90090 of screenshots of a user interacting with location-based Augmented Reality content that exists in the user's proximity and is displayed in the user's field of view (AR View). The ability to interact with this content leverages the lifecache engine to pull location-based data from the lifecache databases in addition to the interaction with technology APIs. The location-based Augmented Reality content consists of both 2D videos & photos and 360-degree videos & photos. The content available on lifecache leverages the database. The user holds up their device to explore and consume location-based Augmented Reality content around the user. Depicted in such a visual is lifecache's custom interactive map that shows the geo-location of content experiences (2D & 360-degree photo/video) on a map where users can search and toggle to any geographic location to see content displayed at that given location. The walk through of the map will show both static and real-time content leveraging the lifecache engine to pull information based on integrated technology APIs. Content is previewed within a circular shape on the map at the location with which the content is associated. Upon entering lifecache, the user is prompted to follow top performing users/creators based on the user's current location. Through connected social media APIs, content is pulled and served to the user allowing the user to post the user's content from other social media into lifecache in a simple one-click function.

Capture and posting user Moments are a core focus of the application. Moments can be either 2D or 360-degree photos or videos. These moments will be pulled from the lifecache database using the lifecache engine, which will be leveraging APIs to connect to action-camera and also other content creating devices to pull into lifecache. A user can create a moment, which pulls information from the lifecache database, and when posting, a user will have the ability to leverage the lifecache engine to post content at either the user's current geographical location, or leveraging the lifecache engine, a user can push content to any chosen geographical location for immediate real-time consumption both on the Map View and the location-based Augmented Reality Experience (AR View). A user can choose media from the user's mobile device camera roll in addition to the user's connected action-camera. A user can also capture directly in the application through the camera feature/function. The lifecache engine will compress, format, and optimize media that is pulled into the lifecache platform. This media content will reside securely within the lifecache databases. A user can add a title or name to the user's Moments. A user can add a description for the user's Moments. A user has the option to tag others within the platform. A user can select an emotion for the moments the user captures. A user can add AR stickers & characters to the user's moments. A user can add AR Mesh Affects to the moments for previewing in AR View. A user can add audio to the user's moments. While posting to lifecache, a location is automatically generated for the Moment based on the meta-data embedded in the content media file. Additionally, the user also has the option to search for any location globally to select as the location to post the user's moment. Using the lifecache engine and integrated lifecache map, the user will be able to leverage custom map integrations to be able to post and explore content for immersive consumption.

Capture and posting Partner content are feasible. Partners have all of the Capture & Posting features as users as well as the below added features: a Partner can add links that are integrated into the Moment that navigate users to the Partner's online page or store for purchasing; a Partner can add links that are integrated into the Moment that navigate users to the Partner's online page/store to book reservations; a Partner can add links that are integrated into the Moment to navigate users to the Partner's online page or store to learn more about the Moment; a Partner can, using the lifecache engine, have the ability to “boost” the Partner's post or Moment for increased discoverability to outside users on the lifecache platform.

Capture and posting of 360-degree content and action camera integration are feasible. The lifecache platform enables content captured on Action-Cameras such as the Go-Pro Max, Insta360, and Canon's 8K EOS R5 camera to be directly uploaded to lifecache via Bluetooth. The lifecache engine is leveraged to compress, format, and optimize the content for consumption to be posted on the lifecache platform. The lifecache engine supports 360-degree files converted into MP4 formats to enable high quality and low latency content. The lifecache engine is used to sustain a high-quality compressed video file for 360-degree posting. The lifecache engine will be used to manage 360-degree content based on a number of variables including length capacity.

Livestream Content and Live Streaming are enabled through the lifecache streaming engine that optimizes content to be leveraged through streaming APIs. The lifecache engine is leveraged to compress, format, and optimize the livestream content for consumption to be posted on the lifecache platform. The lifecache engine supports livestream files converted into MP4 formats to enable high quality and low latency content. The lifecache engine is used to sustain a high-quality compressed video file for livestream posting. The lifecache engine will be used to manage livestream content based on a number of variables including length capacity.

Map View in lifecache provides a custom map view that is the main screen typically appearing when a user logs into the lifecache platform. Within the Map View, the user is able to toggle through the Map View and AR views. The UI and UX of the Map View adjust to different viewing displays and designs based on the time of day. Leveraging location-based services, the map defaults to a display of the user's current location when initially opened. The lifecache platform provides a custom map enabling the user to leverage gestures provided by technology APIs. These gestures enable the user to have a customized navigation and discovery experience on lifecache. Users can navigate to different locations on a map via touch screen capabilities. Users can perform zoom-in and/or zoom-out actions at any location using touchscreen capabilities such as “pinch to zoom” or the zoom-out button features on the top right of the screen. A user can also quickly navigate to any geo-location using the search navigation feature, which allows the user to be able to navigate to any address, area, or region to explore Moments in that location.

Moments that share the same location or a close proximity on the map are grouped together as a “cluster” at certain aerial views of the map that are more zoomed-out. Clusters group Moments together and indicate the number of Moments that share a given location. If a user taps or selects a Cluster, a drop-down list of the different Moments will appear previewing the content captured in the Moment and the title of the Moment. A user can tap or select a Moment from the drop-down list to open and invoke that Moment to consume the content captured.

Certain users may have permission to access an Admin Map View. Admins have the ability to choose between the Map Views of any user on the lifecache platform.

The lifecache AR View leverages Augmented Reality enabling a user to use the device camera to invoke AR functionality within the lifecache engine for real-time content discoverability. The AR module makes use of the smartphone sensors like GPS, Gyro, and Accelerometers, in addition to other sensors like LIDAR (in some devices), to give an accurate digital representation of location-based AR. Using the lifecache engine, content for the AR module is pulled from lifecache databases and populated and displayed in the mobile device showcasing virtual content plotted in the user's surroundings. Depicted in FIG. 9D is the AR View that shows Moments in a location-based Augmented Reality view. Moments for the AR View are pulled from the lifecache database and rendered in the camera view in the user's surroundings. Moments are pulled from the lifecache database and displayed in an interactive location-based experience, which is integrated with the lifecache custom Map showcasing Moments at their precise locations using GPS longitude/latitude coordinates. Using location-based data, the AR View calculates the real-time proximity of Moments, where Moments that are further away visually adjust in size to appear smaller and Moments that are closer adjusting to a larger visual size.

In an Interactive Portal AR View, the shape and interaction of the AR content display renders a “portal” that is a content experience allowing users to “walk in” and “walk out” of both livestream and pre-recorded 360-degree Moments for a more immersive experience. Using the lifecache engine, media content available within the lifecache databases is then compiled and enabled for livestreaming via technology APIs and the custom lifecache streaming engine that can be rendered in real-time within the AR view. Moments are displayed at their directional locations with moments located to the North, South, East, and West of the user only appearing in the user's field of view when the user points in a direction containing the Moments directional location in the AR View. AR View displays 360-degree photo and video content in a 3D display indicating the 360-degree nature of the media file. The lifecache Vantage Points enable a user to view different angles of the 360° videos by moving the user's phone in different directions to show different angles of an opened 360-degree video or photo. Additionally, lifecache provides the ability to view different angles within the 360° video & photo content using touch screen capabilities on the device screen where user can see different vantage points within the 360° experience.

User engagement often involves opening a Moment. In AR View, a user can open and invoke a Moment by selecting a Moment using touchscreen capabilities, gestures, or voice command. Such control actions invoke Moments within a user's field of view. When a user selects a Moment using one of the touchscreen capabilities, gestures or voice command, the user will hear a custom media sound (e.g., chime) designating that the user is entering a Moment. In-Moment Interactions allow a user to interact with a Moment. Media files (e.g., videos specifically) are streamed directly from secure AWS S3 buckets using CloudFront. For 360-degree content experiences, a user can navigate within a 360-degree field of view-to-view different angles of 360° videos by moving the user's phone in either a horizontal, vertical, diagonal, and circular motion within a spherical view showing different vantage points of the video. The lifecache platform provides the ability to view different angles within the 360° video & photo content using touch screen and other sensory and gesture capabilities on the device where a user can view different vantage points within the 360° experience.

Trails are collections of data in the lifecache platform. Trails are a linked collection of moments that are sourced from the lifecache databases. A user can invoke a Moment that is a part of a Trail. When a Moment from the Trail is opened and invoked, content is pulled from the lifecache database displaying additional media that is within the nearby geographical radius of the user. The lifecache platform uses custom algorithms to pull relevant data within the lifecache engine to provide relevant moments that aid in discoverability.

The lifecache platform enables users the ability to combine and synch individual Moments together in a single experience as a Trail. As a single experience (Trail), lifecache provides a custom interaction that directs users to the different geographical locations where Moments are located. A user can invoke a Moment that is a part of a Trail. When a Moment from the trail is opened and invoked, content is pulled from the lifecache database displaying additional media that is within the nearby geographical radius of the user. The lifecache platform uses custom algorithms to pull relevant data within the lifecache engine to provide relevant moments that aid in discoverability. The lifecache platform provides the ability for a user to create the user's own Trail using media the user has created from the lifecache database. A user can sort through the different Moments contained in a Trail using a vertical toggle function within the Trail preview module that previews the content within a given Moment. A user can tap or select the Moment to invoke the content captured inside. The content within the Trail preview module can also automatically invoke based on a timed process where if opened, the Trail will invoke each subsequent moment of the linked Trail.

A user may discover People or Trails, in which the lifecache search functionality uses custom AI from lifecache to pull various data points from the lifecache databases to search and discover people and Trails based on the user's interests. Based on the lifecache algorithms, a user is able to search and discover relevant data that allows the user to better explore other users and trails around the user. These algorithms leverage data from the lifecache databases. The lifecache platform leverages data points within the lifecache database engine that populates nearby Trails from the people that the user follows. This function also includes relevant data sourced through the lifecache algorithms that feed popular Trails.

The User Profile is an important component of the lifecache platform. The profile module is the control center for a user's activity in the app. There are features that allow a user to see the user's followers or following, change the user's profile picture and choose a new username in addition to other standard features like privacy and app shortcuts. Settings may be entered in a user profile. A user is provided basic settings related to the user's profile login and username credentials, such as Action Camera Settings, Editing Settings, Location-based Settings, Face Recognition Settings, Gesture Settings, and Privacy & Security Settings.

The platform involves various permissions. The app requires explicit permissions from the user in order to provide the best experience. Major permissions requested are Location access, Push notifications, and Camera/Media library access. Explicit permission allocation is required to comply with both Apple & Google rules and guidelines. No unauthorized access to the user's location or data is done by the platform.

The platform includes an Admin Panel. The user type ‘Administrator’ or ‘Admin’ is a high-level user capable of managing some or all users and the users' moments and trails shared from the app side. An Admin has the only privilege to create partners by providing basic details including partner email ID. Moreover, all partners created from the Admin dashboard can be manipulated by the administrator. An Admin user is created at the database level with username (e.g., email) and password.

The lifecache platform includes an online Portal as an alternative means of accessing the platform. Content Partners may access the portal using an Admin View. The Admin and Partner View of the Content Partners tile will show moments created by content or ad partners on the mobile, desktop, laptop, wearable, or headset. A Tile represents each individual Partner or Content partner. By selecting a tile, the Admin can gain access to all content created by the specific partner. The Tile View is a display of all Partners or Content Partners on the lifecache platform. Content Partners include media partners producing the content available on the lifecache platform via the partner access credentials. Content Partners can be displayed via the lifecache map by toggling between tile view and map view. Content on map can be filtered based on variables such as industry, spend, city and other data factors from lifecache databases. Using AI, lifecache will feed or recommend relevant insights to Content Partners based on data points generated from the lifecache engine. This prompt will allow Content Partners to pull data from lifecache user activity to create strategic interactive content. Data will be organized using custom lifecache algorithms referencing high-impact Content Partnership data. Content Partners will list available plugs-ins for back-end integration to enable feature add on such as streaming and other digital integrations into lifecache using technology APIs. Content Partners will allow plug-in review for feature feedback from associated partners within the lifecache ecosystem. Plug-in review enables users to gather information on content or ad partners. Content Partners will provide plug-in support for transactions within the lifecache platform. The admin can view, edit, enable, and disable any “Content Partnership” accounts, data, or plug-ins.

The lifecache platform enables an Admin View of 360-Degree Content. The Admin and partner view of the 360° Content tile will display moments created in 360° from Action Cameras such as GoPro, Insta360, Canon Cameras and other 360°-, AR-, or XR-creating devices. An Admin can select the option to display the “360” moments that will show 360° moments sorted based on those uploaded from the Desktop vs Camera. An Admin can select the option to display the “360” moments that will show integration options for cameras. An Admin can select the option to display the Editing Tools and Plug-Ins for 360° Video. An Admin can edit, enable, and disable any 360° content or plug-ins within the system.

The platform leverages Location-Based Services (“LBS”) and includes an Admin View. The Admin View of the LBS (Location-Based Services) data button, when selected, will show all content and Moments and key data related to the location of where moments were captured. The “Location-Based” map button will open a custom lifecache map showcasing memories and the geographical locations at which they were captured. The “Location-Based” data will show a heat map highlighting the locations that are “hot zones” representing the location where the most Moments took place. The “Location-Based” map will provide a filtering button based on key data points provided by lifecache data sets. The “Location-Based” map provides a button that will pull data from the lifecache databases to develop AI-based reports and analytics to better serve partners and users of lifecache. The “Location-Based” map provides a button that will enable partners to leverage digital plug-ins to push integrated content. The admin will be able to edit, enable, and disable any “Location-Based” content and plug-ins, including managing access to partners.

The platform enables various types of Subscriptions, including an Admin View. An Admin can view partners based on paid subscriptions by selecting the Subscription button. This selection will display paid subscription partners on the platform by logo. An Admin can select option to filter value of each partner on the system. An Admin can view partners based on ad spend on the portal. An Admin can view partners based on content interaction on lifecache. An Admin can track subscription start and expiration dates.

The platform enables both User and Partner Trails and includes an Admin View. When logged into portal as an Admin, an Admin can select a Trail option and view map of all trails and scavenger hunts on the map created by users or partners. When logged into portal as an Admin, an Admin can select to view map of all Trails and scavenger hunts on the map. An Admin can create, manage, and edit scavenger hunts from the Portal. Trails are derived from photos & videos (Moments) pulled from the lifecache database and stitched together into a scavenger hunt like experience. An Admin has the ability to view Trail highlights and the engagement of each Trail per location. An Admin has the ability to view Trail highlights on the lifecache heat map that feed insights into engagements of each Trail. An Admin has the ability to upload, edit, and manage the 360-degree content within a Trail. An Admin has the ability to add 3D, animations, or other AR elements to a Trail from the Portal. An Admin has the ability to integrate ads or marketing elements to the Trail. An Admin has the ability to push Trails to any geographical location from Portal and End address. An Admin has the ability to push/post a URL that when executed provides streaming capability to the user. An Admin has the ability to push or post a time sensitive Trail to a location that disappear after given time length expires. An Admin can access Trail reports and analytics outlining interaction from Trails. An Admin can create campaigns using elements from content partnerships

The platform enables User Moments and includes an Admin View. An Admin can select moment and view user Moments that can be listed and organized via filters. User Moments filtered by type of memory, e.g., 2D, 3D, 360-degree, audio. User Moments may show engagement data on memory, e.g., likes, views, interactions, etc. User Moments may show an option to edit, manage and update. User Moments may show an option to add to Trail to a campaign.

The platform enables Editing Moments with lifecache Editing Suite and includes an Admin View. A user can upload and begin editing moments including 2D, 3D, and 360-degree content. A user can select an option within the lifecache editing suite to make changes, make updates, and enhance any 2D, 3D or 360-degree content uploaded to lifecache. lifecache editing suite includes spherical editing, file size editing, panorama editing, color editing, size editing, 360° editing and more. A user can upload multiple photos, videos, and 360° degree content. A user can select an option to stitch together a 360-degree Moment using the lifecache editor. A user can add Augmented Reality Digital Elements to existing 360-degree content created using the lifecache editor suite. A user can add digital stickers to any created content using the lifecache editing suite. A user can view a preview of the edit before publishing. A user can view the size of the 360-degree content before and after publishing to confirm supported size elements in lifecache. A user can select, edit, and make changes to any previously posted moments on the platform that the user has published. An Admin can view and/or remove all 360-degree content published on lifecache.

The platform enables creation and management of Partner Moments via a Partner View. Partner Moments may be listed and organized via filters. Partner Moments may be filtered by type of memory: 2D, 3D, AR, etc. Partner Moments may show engagement data on memory: likes, views, interactions, etc. Partner Moments may show active campaign times when used in campaign. Partner Moments may show options to edit, manage, and update Moments. Partner Moments may show options to add to a Trail to a campaign. Partner Moments may be map-enabled showcasing user moments on Map View. Partner Moments may be plotted on a heatmap.

The platform enables a Partner's Editing Moments with the lifecache Editing Suite via a Partner View. Partner may login and select Moments in Portal to view Moments created. A Partner can upload and begin editing moments including 2D, 3D and 360-degree content. A Partner can use the lifecache editing suite to make changes, make updates, and enhance any 2D, 3D or 360-degree content uploaded to lifecache. lifecache editing suite may include spherical editing, file size editing, panorama editing, color editing, size editing, 360° editing and more. Partners can upload multiple photos, videos, and 360-degree content and use the lifecache stitch feature to stitch together a 360-degree Moment using the lifecache editor. Partners can add Augmented Reality digital elements to existing 360-degree content created using the lifecache editor suite. Partners can add digital stickers to any created content using the lifecache editing suite. Partners can import and/or upload digital elements from other tools to add to content using the lifecache editing suite. Partners can view a preview of the edit before publishing. Partners can view the size of the 360-degree content before and after publishing to confirm supported size elements in lifecache. Partners can edit and make changes to any previously posted moments on the platform that they have published and own. Partners can filter based on sentiment elements. Partners can add digital elements from lifecache partnership into the campaign or content creating using lifecache editing suite. An Admin can view and/or remove all 360-degree content published using the lifecache editing suite.

The platform enables various Admin Analytics. An Admin can select an Admin tab to view Analytics. An Admin can select map option to view all memories on the platform on the map. An Admin can view heat maps to detect memories with the most activities. An Admin can filter memories based on type; 360°, Photo, Video, Partner, User, Campaigns. An Admin can view sentiment detail on each memory. An Admin can filter based on sentiment. An Admin can obtain general statistics on memory count.

The platform enables various Partner Analytics. Partners can select map options to view all memories on the platform on the map. Partners can view heat maps to detect memories with the most activities. Partners can filter memories based on type: 360, Photo, Video, Partner, User, Campaigns. Partners can view sentiment detail on each Moment. Partners can filter based on sentiment. Partners can filter view based on recommended Moments, AI keywords, other partner Moments on the map. Partners can view content partnership engagement based on integrations into campaigns created using lifecache editing suite. Partners can gain general statistics on memory count.

The platform enables various Content Partnerships. The content partnership tab can be selected to gain insight on partnerships on lifecache. The Partner View of the “Content Partnerships” tile will show Moments created by content or ad partners on the mobile, desktop, laptop, wearable device, or headset available for campaign use. “Content/Ad Partnerships” include content partners available on the lifecache platform via Partners. “Content/Ad Partnerships” can be displayed via the lifecache Map View or Tile View. Content on the map can be filtered based on variables such as industry, spend, city and other data factors from lifecache databases. “Content/Ad Partnerships” will pull data from lifecache user activity providing information to manage the effectiveness of partners using AI. “Content/Ad Partnerships” will organize data points to reference high impact Content Partnership data. “Content/Ad Partnerships” will list available plugs-ins for back-end integration to enable feature add on such as streaming and other digital integrations into lifecache using technology APIs. “Content Partnerships” will allow plug-in review for content partners. Plug-in review enables users to gather information on a content/ad partner. The Partner view of the “360” moments tile will show moments created in 360° from Action Camera's such as GoPro, Insta360, Canon Cameras and other 360°-, AR-, or XR-creating devices. Partners can view the “360” tile that will show 360° moments uploaded from the Desktop. Partners can view the “360” tile that will show integration options for cameras. Partners can view the “360” tile that will show the editing tools and plug-ins for 360° video. The Partner View of the “Location-Based” data tile will show key data related to the location of where moments were captured. The partner can view the “Location-Based” data tile to open a custom lifecache map showcasing memories and the geographical locations they were captured. The Partner can view the “Location-Based” tile to show a heat map highlighting the locations that are “hot zones” based on varying metrics, such as: location volume, Moment engagements, recent Moments, etc. The partner can view the “Location-Based” tile, which will show filtering options based on key data points provided by lifecache data sets. The Partner can view the “Location-Based” tile to pull data from the lifecache databases to develop AI based reports and analytics to better serve partners and users of lifecache. The Partner can view The “Location-Based” tile to enable partners to leverage digital plug-ins to push integrated content.

The platform enables various types of Analytics. lifecache provides both reports and analytics for the Admin and partners. Reports and Analytics are pulled from multiple sources including lifecache databases, API/Integration Data, public data, and additional data pulled from connected sources. lifecache will be providing reports and analytics related to the following: Moment Engagement Reports & Analytics; Trail Engagement Reports & Analytics; Location Based Reports & Analytics; Media Type Reports & Analytics; Hot Spot Reports & Analytics; Active Duration Reports & Analytics; Portal Engagement Report & Analytics; Content Partnership Engagement Reports & Analytics; Heatmap Reports & Analytics; Sentiment Reports & Analytics; Traffic Source Reports & Analytics; Interest Reports & Analytics; and Partner Reports & Analytics.

The platform enables various methods of managing Moments. lifecache provides the ability for partners to upload and manage moments via the lifecache portal. This feature enables partners, via subscription, to gain access to a tiered feature set provided by lifecache. The following functions are provided for partners: Partners can create, manage, and edit Trails from the portal; Trails derived from 2D or 360-degree photos/videos (Moments) may be sourced from the lifecache database and stitched together in a scavenger hunt like experience; Partners will be provided with tools allowing them to “stitch” or “pull together” Moments that will create Trails. The Trails are Moments pulled from the lifecache Databases, which include a variety of media types such as: 2D, 3D, 360, Audio, livestream media; Partners can receive and select option to view engagement data of Trails per location; Partners can select options to view trails plotted on a heat map and are color coded based on engagement; Partners can edit, update, and manage Trails; Partners can add 3D, Animation, or other additional AR elements to Trail; Partners can integrate ads and marketing elements to the Trail; Partners can select to proactively push Trails to other geographical locations for boosted discoverability; Partners can integrate a URL that, when executed, provides streaming capability to the user within Trails; Partners can push time sensitive Trails to the map that disappear after engagement; Partners can access Trail reports and analytics outlining interaction from Trails; and Partners can create campaigns using elements from content partnerships.

The platform enables various aspects of Action Camera Connectivity, including for Partners. The lifecache Portal provides the ability for Partners to connect external sources, such as Action Cameras, and gain access to the media file. This access enables partners to upload, manage, and share content via the lifecache portal. Partners can connect to action camera to upload photos, videos, and 360° content. Post-editing, partners can push Moments to any geographical location.

The platform enables various aspects of managing Trails, including by an End User. lifecache provides the ability for End Users to upload and manage moments via the lifecache portal based on Tiered access. This feature enables an End User, via subscription, to gain access to a tiered feature set provided by lifecache. The following functions may be provided, including that an End User can create, manage, and edit Trails from the portal. Trails are derived from photos & videos (Moments) pulled from the lifecache database and stitched together into a scavenger hunt like experience. End Users will be provided with tools allowing them to “stitch” or “pull together” Moments that will create Trails. The Trails are Moments pulled from the lifecache Databases that may include a variety of media types such as: 2D, 3D, 360, Audio, and livestream media. End Users can edit, update, and manage Trails. An End User can upload, edit, and manage 360° content to add to a Trail. An End User can add 3D, Animation, or AR elements to Trail. An End User can add ads or marketing elements to the Trail in between moments of the Trail.

The platform enables various aspects of managing Trails for Partner & Admins. lifecache provides the ability for Admins and Partners (based on Tiered access) the ability to upload and manage moments via the lifecache portal based on Tiered access. This feature enables Admins and Partners (based on Tiered access) to gain access to a tiered feature set provided by lifecache. The following functions are provided: an Admin or a Partner can view map of all Trails and scavenger hunts on the map; an Admin or a Partner can log into Portal and manage Trails from portal; an Admin or a Partner can create, manage, and edit scavenger hunts from the Portal; an Admin or a Partner has the ability to view Trail highlights the engagement of each Trail per location; an Admin or a Partner has the ability to view Trail highlights on the lifecache heat map which feed insights into engagements of each Trail; an Admin or a Partner has the ability to upload, edit, and manage the 360-degree content within a Trail; an Admin or a Partner has the ability to add 3D, animations, or other AR elements to a Trail from the Portal; an Admin or a Partner has the ability to integrate ads or marketing elements to the Trail; an Admin or a Partner has the ability to push Trails to any geographical location; an Admin or a Partner has the ability to push or post a URL that, when executed, provides streaming capability to the user; an Admin or a Partner has the ability to push/post a time sensitive Trail to a location that disappear after given time length expires; an Admin or a Partner can access Trail reports and analytics outlining interaction from Trails; an Admin or a Partner can create campaigns using elements from content partnerships; only an Admin can manage, edit or delete all Trails on the lifecache Platform regardless of creator. End Users and Partners cannot delete any content on lifecache if they are not the creator.

The platform enables use of a Headset. The lifecache Headset Experience provides features developed specifically for headsets such as Oculus, Snap Spectacles, Apple MR Glasses, Magic Leap MR Headset, and other headset and wearable Mixed Reality devices. The lifecache Headset Experience provides custom features designed to maximize the feature set and technology of its respective hardware. Features include, for example, Interactive walkthrough screen consisting of live actionable “bubbles” that represent lifecache AR Moments. Each Moment leverages sensors and gestures. Each Moment highlighted based on the user's geographical location. Each Moment represents various features in lifecache. Interactive users may sign-up process using Facebook, Email, Discord, and other platforms. The Interactive experience leverages Plug-Ins, APIs, and other Digital Assets to enhance the experience. A user can reset a password using a variety of interactive actions including Gesture, Voice Command, and other interactive commands based on its respective hardware it is integrated with.

The platform enables a Headset Map View when using a Headset. The lifecache Map View provides a custom Map experience using APIs, Plug-Ins, and advanced technology to place Moments, Capture Location-Based Data, and also provide relevant information pulling from the various data points provided by lifecache. Map View with interactive Augmented Reality and Mixed Reality overlays. A user can toggle from Map View to AR View. Map View will have integrations and plug-ins providing relevant interactive content such as: Weather, News, Stocks, Email, etc. Map View will provide proximity relevant suggestions via Augmented Reality and Mixed Reality overlays. Suggestions include but aren't limited to: Restaurants & Specials, Shopping Experiences, Entertainment Attractions, Open Wi-Fi Venues, etc. Map View will render Moments that are in the user's geographical location or proximity based categorical options such as: Friends, Interests, Food, Entertainment, Sentiment. A user can zoom in and out of locations on the interactive lifecache Map. A user can leverage 360° spherical features to explore location of memory. From Map View, a user can search a specific location based on variables such as: Address, City, Business Name, username, etc.

The platform enables a Headset AR View when using a Headset. The lifecache Headset AR View provides an interactive real-life visualization of the end user's current view. Leveraging AR, lifecache places AR Moments (Digital Content), Objects and Interactions that are pulled from the lifecache databases within the geographical view of the end user. These AR Moments provide a variety of interaction options. AR View is the default view for the lifecache Headset Experience showcasing AR Moments and other relevant content in the user's live view. A user can toggle from AR View to Map View using gestures, voice command, and active action features within the experience. AR View will have integrations and plug-ins providing relevant interactive content such as: Weather, News, Stocks, Email, etc., overlayed in AR. AR View will provide proximity relevant suggestions via Augmented Reality and Mixed Reality overlays. Suggestions include but aren't limited to: Restaurants & Specials, Shopping Experiences, Entertainment Attractions, Open Wi-Fi Venues, etc. AR View will render Moments that are in the user's geographical location or proximity based categorical options, such as: Friends, Interests, Food, Entertainment, Sentiment overlayed in AR. AR moments will display a proximity meter to highlight the distance of a Moment from the user's current location. When looking at points of interest, AR overlays will pop-up and invoke relevant information on selected physical locations or locations in focus. In AR View, user can walk into 360-degree content Moments and be immersed in a 360-degree spherical view of the opened Moment (video or photo). User can then walk out of the Moment to exit the content experience and re-enter live AR View. The actions associated with entering and exiting a 360-degree immersive Moment are indicated by entry and exit audio sounds, e.g., chimes. In AR View, a user can walk into a moment and interact with AR/MR overlays within opened Moment

The platform enables experiencing Headset Trails when using a Headset. The lifecache Headset Trails provides a custom interactive experience for the end user based on a collection of Moments connected together to form one experience. Headset Trails enable the end user to Teleport, Discover, and Experience a collection of Moments using AR, Portals, and other interactive experiences. Headset Trails provide the following: a User can see an AR overlay of the Trail that provides a preview mode of Moments within the Trail; a User can see overlay of Trail experience including Time, Sentiment, Number of Experiences, and Reviews within the preview mode; a User can interact with Trail via Map View and see AR overlay of distance between the Moments that make up the Trail; when a User is exploring locations on the Map View, related Moments are displayed in AR overlays that relate to the selected location; Users can have group Trails that enable a co-player experience with other headset users. This allows them to interact with the same Trail of content together in the lifecache experience. A User can interact with parts of Trails or Trails to its entirety. If a user opts to leave a Trail, the user can rejoin the Trail at the time the user chooses to rejoin; and Users can leave a “signature” that is a digital stamp of their consumption of a Moment within a Trial, i.e., “John was here.”

The platform enables Headset Moment Creation when using a Headset. Headset Moment Creation via lifecache allows the user to leverage the Headset Media Capture capability to capture unique and immersive content designed for the Headset experience. This function includes capturing content from both Mixed Reality headsets and glasses. A User can create Moments using video, photo, 360°, and other elements from the VR/MR headset or glasses. Users can upload Moments captured on the VR/MR headset or glasses to the lifecache experience.

The platform enables Discovery of content. The lifecache Discovery option for the Headset and Glasses leverages API's, Integrations, and AI to provide a unique discovery experience for Partners and End Users. lifecache Discovery provides the following features: an End User or a Partner can discover Moments based on geographical location, interests, and other data points provided by the lifecache engine; an End User or a Partner can use verbal commands and gestures to select and input commands when discovering; lifecache will use AI and custom algorithms to provide discovery options for each End User and Partner; an End User can manage the user's ability to be discovered within the lifecache options; an End User can opt to be discoverable to only select Friends, and select Followers; an End User can opt to be discoverable only by Content, but not from Username, to remain private; an End User can use Map View to search geographical location; an End User can use Map View to pull, spin, zoom, and interact with Geographical Location within the Map; a Partner can leverage lifecache Algorithms to Discover End Users to fit Campaigns and Content Match; and a Partner can use real-time Map View Heat Maps to view Hot Zones to discover new content and to which to push the Partner's own content.

The platform enables various aspects of Live Streaming. lifecache Live Streaming provides streaming capabilities pulling data from the lifecache Databases. lifecache streaming leverages the lifecache Custom Streaming feature to provide real time Headset Streaming to Users. Live Streaming provides various possibilities, including that an End User can use gestures to start, stop, pause, and interact with streaming content provided by the lifecache streaming engine. When an option is selected, an End User can select from lifecache Content Partnership library to stream content from respective Headset. An End User can leverage In-App purchases to engage with Items within the streaming engine using Interoperability and Integration with other Content providers provided by lifecache. An End User can enable real time streaming from the respective Headset using lifecache streaming engine to enable recipient to view real time screen share

The platform enables experiencing a Real Time Moment. lifecache Real Time Moment feature allows end users to Teleport to a Real Time Moment enabled by another lifecache user. lifecache Real Time Moment leverages the lifecache Streaming Engine to allow users to share experiences and Moments in real time. Features allow, for example, that a User can select “Real Time Moment” button and select from existing followers to share their current view from the respective Headset. A User can interact with existing followers, or with pending followers who are also using a Headset with lifecache installed. Interactions may include, for instance, Gestures, Voice and Content Share within view.

The platform enables various features in User Profile management. lifecache provides the ability for a User or a Partner to create a custom profile that can be used within lifecache. The lifecache profile leverages APIs and Integrations to provide a unique profile persona for the End User or Partner. Features may includes, for instance, a Partner or an End User can create a custom avatar in lifecache pulling data from various APIs and Integrations using the lifecache engine. A Partner or an End User can create custom profile attributes, including, for example, Themes, Colors, Media, and other items to customize the Profile and Persona. A Partner or an End User can leverage integration with other Technologies and Software to pull profile information from other systems into the lifecache engine.

The platform enables various features relative to Permissions. The Headset and Glasses permissions will be powered and controlled by the lifecache Administration features. The lifecache Administrator features enable, for example, that an Admin can control 3^{rd}-party Content enabled within lifecache; an Admin can retrieve Data via Reports and Analytics that are specific to the Headset activity; an Admin can disable End Users and Partners from accessing content via the Portal; and an Admin can disable End Users and Partners from allowing access to content outside of the portal.

At a high level, the lifecache platform may cast the visual display from a smartphone, running the app, to a head-mounted display (HMD) for viewing. In other words, the smartphone and app on the smartphone provide connectivity to the server and generate screen views, and the HMD display the views to the user for a more immersive experience (either duplicating what is displayed on the smartphone screen, or acting as a second monitor showing different content). This configuration may be useful, interesting, or commercially-important as, and/or if, future users use HMD-style devices for or from Meta/Facebook, even if the HMD-style device is locked, or incompatible, to prevent the lifecache app from running directly on the HMD-style device (assuming the HMD device can receive and display third-party pass-through content).

Regarding the use of the touchscreen of the smartphone while a user wears the HMD, the HMD could include an image of the screen of the smartphone, with an image (e.g., a floating dot or cursor icon) that indicates where the user's finger touches the smartphone screen, allowing a user to use a smartphone touchscreen without physically being able to see the smartphone because of wearing the HMD.

A smartphone and headset device may synch and/or interoperate based on compatibility, in which lifecache a user can run a connected experience across the user's devices, in which the smartphone has certain controls and features that will interact with the headset display experience. This arrangement may be particularly relevant when Apple releases Apple's AR headset device that, based on predictions, presumably will connect to a mobile smartphone device (possibly only an Apple iPhone), creating a connected experience. The smartphone may act as a remote controller to interact with and select features in the headset experience, in which the smartphone and AR headset are tethered in their controls.

Another option within embodiments of lifecache will be configuring Moments or Memories to create “Autobiographies” or “Flashbacks” as both user experiences and as potential trademark names for such user experiences. For instance, a Flashback would be a “reliving” of an event (e.g., a birthday party) from a participant's experience or point of view (POV). An “Autobiography” would be a user's compilation of the user's own Memories, Moments, or Flashbacks. A “Biography” would a third-party user's compilation of another user's Memories, Moments, or Flashbacks. A “Day In The Life” Of [John Doe] would be a person-specific, day-specific, day-limited compilation of Memories, Moments, and/of Flashbacks for the specific person. For example, a “Day In The Life” of Joe Biden (used only as an example because of available video media) might be the day of President Biden's inauguration, with videos and photos time-sequenced as the depicted events occurred and unfolded. Similarly, a “Day In History” might be a day-specific, day-limited compilation of Memories, Moments, and/or Flashbacks from multiple users as a time sequence for a specific day, possibly focusing on the events of the specific day (e.g., New Year's Eve celebrations as they unfolded around the globe) or on a specific location (e.g., the U.S. Capital Building on 2021 Jan. 6) (used only as a historical example, not because of any political meaning that one group or another might attach to it).

These features and compilations effectively would be, on a server-side, database perspective, a series of pre-defined and refined searches, curated content, and displaying of search results. The curated content is compiled for a specific intent or perspective. The pre-defined searches search for and find content, possibly both activity-specific content (e.g., video of an event) and ‘accompanying’ content (e.g., a context-appropriate, content-appropriate selection of music to overlay and/or accompany the video content as background music). The display algorithm sequences, blends and/or transitions, and displays the content in user-friendly, educational, and entertaining manners, possibly with original audio content, an overlay of licensed musical audio, or a combination thereof, with the display algorithm possibly using artificial intelligence (AI) to select, time, and overlay the audio content according to the theme, concept, visual content, or focus of the compilation (e.g., a slow-playing rendition of the Happy Birthday song might overlay a Flashback of a user's compilation of birthday Memories, Moments, videos, and photos).

Such concepts expand upon the “location-locked” moments or memories, in which lifecache not only can set location as a parameter, but also set time, date, duration, and specific media as a part of the parameters to consume content that has specific relevance. These concepts are very compelling opportunities that have particular relevance for educational content, entertainment content, and news reporting, as well as personal memorials and virtual albums, such as for vacations, and professional compilations, such as commemorative compilations for weddings, graduations, etc.

The foregoing description discloses exemplary embodiments of the invention. While the invention herein disclosed has been described by means of specific embodiments and applications thereof, numerous modifications and variations could be made thereto by those skilled in the art without departing from the scope of the invention set forth in the claims. Modifications of the above disclosed apparatus and methods that fall within the scope of the claimed invention will be readily apparent to those of ordinary skill in the art. Accordingly, other embodiments may fall within the spirit and scope of the claimed invention, as defined by the claims that follow hereafter. In the description above, numerous specific details are set forth in order to provide a more thorough understanding of embodiments of the invention. It will be apparent, however, to an artisan of ordinary skill that the invention may be practiced without incorporating all aspects of the specific details described herein. Not all possible embodiments of the invention are set forth verbatim herein. A multitude of combinations of aspects of the invention may be formed to create varying embodiments that fall within the scope of the claims hereafter. In addition, specific details well known to those of ordinary skill in the art have not been described in detail so as not to obscure the invention. Readers should note that although examples of the invention are set forth herein, the claims, and the full scope of any equivalents, are what define the metes and bounds of the invention protection.

What is claimed:

1. A method, the method adapted for use in displaying computer-generated content, the method comprising:
communicating with an apparatus, the apparatus adapted to be coupled to and in communication with a local software application and a server;
wherein the apparatus comprises:
apparatus electronic circuitry and hardware including:
an apparatus processor;
an apparatus camera, the apparatus camera coupled to the apparatus processor;
an apparatus display, the apparatus display coupled to the apparatus processor;
an apparatus memory, the apparatus memory coupled to the apparatus processor;
an apparatus positioning device, the apparatus positioning device coupled to the apparatus processor;
an apparatus data transfer module, the apparatus data transfer module coupled to the apparatus processor;
an apparatus data transfer device, the apparatus data transfer device coupled to the apparatus processor;
apparatus electronic software, the apparatus software including the local software application, and the apparatus electronic software being stored in the apparatus electronic circuitry and hardware and adapted to enable, drive, and control the apparatus electronic circuitry and hardware;
an apparatus power supply connection, the apparatus power supply connection coupled to the apparatus electronic circuitry and hardware and couplable to an apparatus power supply; and
an apparatus housing, the apparatus housing comprising an apparatus interior and an apparatus exterior housing, the apparatus interior containing the apparatus electronic circuitry and hardware, the apparatus software, and the apparatus power supply connection; and the apparatus exterior housing comprising an apparatus frame enclosing an apparatus optical lens assembly;
wherein the apparatus positioning device is adapted to generate positioning data indicative of at least one parameter of a group consisting of a position, a location, an orientation, a movement, and a point of view of the apparatus;
wherein the apparatus is adapted to transmit the positioning data to the server;
wherein the apparatus is adapted to receive the computer-generated content from the server;
wherein the computer-generated content includes dynamic content changing over time and space in real-time as related events in reality occur;
wherein the dynamic content is selected from a content group consisting of augmented reality content and virtual reality content;
wherein the computer-generated content comprises computer-generated content data encoding video;
wherein the computer-generated content and computer-generated content data are adapted to be generated by the server based on the positioning data;
wherein the computer-generated content is customized to the apparatus based on the computer-generated content data being generated after, but nearly simultaneous to, generation of the positioning data;
wherein the computer-generated content is rendered and displayed on the apparatus display after, but nearly simultaneous to, generation of the computer-generated content by the server; and
wherein an occurrence of data generated, rendered, or displayed after, but nearly simultaneous to, generation of other data occurs within a latency not to exceed one second;
obtaining the positioning data of and generated by the apparatus;
transmitting the positioning data from the apparatus to the server;
receiving the computer-generated content at the apparatus from the server; and
rendering and displaying the computer-generated content on the apparatus display.

2. The method of claim 1, the method further comprising:
communicating from the server to the apparatus;
providing the server;
wherein the server comprises:
server electronic circuitry and hardware including:
a server processor;
a server memory, the server memory coupled to the server processor;
a server data transfer module, the server data transfer module coupled to the server processor;
a server data transfer device, the server data transfer device coupled to the server processor;
server electronic software, the server software stored in the server electronic circuitry and hardware and adapted to enable, drive, and control the server electronic circuitry and hardware; and
a server power supply connection, the server power supply connection coupled to the server electronic circuitry and hardware and couplable to a server power supply;
wherein the server is adapted to generate the computer-generated content based on receiving the positioning data from the apparatus;
wherein the server is adapted to transmit the computer-generated content to the apparatus upon generation of the computer-generated content;
receiving the positioning data at and by the server from the apparatus;
generating the computer-generated content at and by the server based on the positioning data; and
transmitting the computer-generated content by and from the server to the apparatus.

3. The method of claim 1, the method further comprising:
obtaining video data generated by the apparatus camera;
combining the video data in a video data feed with the computer-generated content;
overlaying the computer-generated content over the video data feed; and,
displaying on the apparatus display a combination of the computer-generated content overlaid over the video data feed;
wherein the computer-generated content comprises augmented reality content;
wherein the augmented reality content corresponds to and augments the related events in reality occurring in real-time;
wherein the augmented reality content comprises an augmented reality overlay;
wherein the augmented reality overlay comprises augmented reality overlay data encoding video adapted to be combined with and overlaid over video data generated by the apparatus camera after, but nearly simultaneous to, generation of the augmented reality overlay data by the server; and
wherein a combination of the augmented reality overlay and the video data comprises an augmented-reality-overlaid video encoded by augmented-reality-overlaid video data adapted to be rendered and displayed on the display.

4. The method of claim 1, the method further comprising:
wirelessly transmitting the positioning data from the apparatus to the server;
receiving the positioning data at the server wirelessly transmitted from the apparatus;
transmitting the computer-generated content from the server to the apparatus; and
wirelessly receiving the computer-generated content at the apparatus transmitted from the server;
wherein the apparatus data transfer device comprises an apparatus wireless transceiver; and,
wherein the server data transfer device is in communication with a network wireless transceiver in wireless communication with the apparatus wireless transceiver.

5. The method of claim 1, the method further comprising:
using an intermediate computing device to transmit the positioning data to the server;
using the intermediate computing device to receive the computer-generated content from the server; and
using the intermediate computing device to process the computer-generated content for displaying the computer-generated content on the apparatus display;
wherein the electronic circuitry and hardware and the electronic software further comprise a console and the intermediate computing device;
wherein the console comprises the apparatus processor, the apparatus camera, the apparatus display, the apparatus memory, the apparatus positioning device, the apparatus data transfer module, the apparatus data transfer device, related aspects of the apparatus software, the apparatus housing, and the apparatus power supply connection;
wherein the console may be referred to as a viewer;
wherein the intermediate computing device comprises another processor, another memory, another data transfer module, another data transfer device, other aspects of the apparatus software, another housing, and another power supply connection;
wherein the intermediate computing device may be referred to as an auxiliary processing unit;
wherein the auxiliary processing unit is electronically couplable to the console; and,
wherein the auxiliary processing unit is adapted to handle aspects of data transfer and data processing separately from the console in generating, transferring, and processing the computer-generated content.

6. The method of claim 1, the method further comprising:
using the apparatus to create and locally save content that defines a Moment;
using the apparatus to associate and locally save the positioning data with the content to create the Moment;
transmitting the Moment as user-created data to the server;
storing the Moment as user-created data in a database in communication with the server; and
managing the Moment and the user-created data within the local software application and within a server software application.

7. The method of claim 6, the method further comprising:
using the apparatus to interact with and manage the Moment; and
using the apparatus to download the Moment from the database via the server.

8. The method of claim 7, the method further comprising:
using the apparatus to share access to the Moment with an account of another user; and
using the account of another user to access the Moment via the server.

9. The method of claim 6, the method further comprising:
using the apparatus to combine a first Moment and a second Moment to create a Trail;
using the apparatus to locally save the Trail;
transmitting the Trail as user-created data to the server;
storing the Trail as user-created data in a database in communication with the server; and
managing the Trail and the user-created data within the local software application and within a server software application.

10. The method of claim 9, the method further comprising:
using the apparatus to interact with and manage the Trail; and
using the apparatus to download the Trail from the database via the server.

11. The method of claim 1, the method further comprising:
using the apparatus to create and locally save a plurality of instances of content that defines a Trail;
using the apparatus to associate and locally save the positioning data of each instance of content with each instance's content to create the Trail;
transmitting the Trail as user-created data to the server;
storing the Trail as user-created data in a database in communication with the server; and
managing the Trail and the user-created data within the local software application and within a server software application.

12. The method of claim 11, the method further comprising:
using the apparatus to interact with and manage the Trail; and
using the apparatus to download the Trail from the database via the server.

13. An apparatus, the apparatus adapted for use in displaying computer-generated content, and the apparatus adapted to be coupled to and in communication with a local software application and a server, the apparatus comprising:
apparatus electronic circuitry and hardware including:
an apparatus processor;
an apparatus camera, the apparatus camera coupled to the apparatus processor;
an apparatus display, the apparatus display coupled to the apparatus processor;
an apparatus memory, the apparatus memory coupled to the apparatus processor;
an apparatus positioning device, the apparatus positioning device coupled to the apparatus processor;
an apparatus data transfer module, the apparatus data transfer module coupled to the apparatus processor;
an apparatus data transfer device, the apparatus data transfer device coupled to the apparatus processor;
apparatus electronic software, the apparatus software including the local software application, and the apparatus electronic software being stored in the apparatus electronic circuitry and hardware and adapted to enable, drive, and control the apparatus electronic circuitry and hardware;
an apparatus power supply connection, the apparatus power supply connection coupled to the apparatus electronic circuitry and hardware and couplable to an apparatus power supply; and
an apparatus housing, the apparatus housing comprising an apparatus interior and an apparatus exterior housing, the apparatus interior containing the apparatus electronic circuitry and hardware, the apparatus software, and the apparatus power supply connection; and the apparatus exterior housing comprising an apparatus frame enclosing the apparatus optical lens assembly;
wherein the apparatus positioning device is adapted to generate positioning data indicative of at least one parameter of a group consisting of a position, a location, an orientation, a movement, and a point of view of the apparatus;
wherein the apparatus is adapted to transmit the positioning data to the server;
wherein the apparatus is adapted to receive computer-generated content from the server;
wherein the apparatus is adapted to render and to display the computer-generated content on the apparatus display;
wherein the computer-generated content includes dynamic content changing over time and space in real-time as related events in reality occur;
wherein the dynamic content is selected from a content group consisting of augmented reality content and virtual reality content;
wherein the computer-generated content comprises computer-generated content data encoding video;
wherein the computer-generated content and computer-generated content data are adapted to be generated by the server based on the positioning data;
wherein the computer-generated content is customized to the apparatus based on the computer-generated content data being generated after, but nearly simultaneous to, generation of the positioning data;
wherein the computer-generated content is rendered and displayed on the apparatus display after, but nearly simultaneous to, generation of the computer-generated content by the server; and
wherein an occurrence of data generated, rendered, or displayed after, but nearly simultaneous to, generation of other data occurs within a latency not to exceed one second.

14. The apparatus of claim 13, the apparatus further characterized:
wherein the apparatus camera is adapted to generate video data;
wherein the apparatus is adapted to combine the video data in a video data feed with the computer-generated content;
wherein the apparatus is adapted to overlay the computer-generated content over the video data feed;
wherein the apparatus is adapted to display on the apparatus display a combination of the computer-generated content overlaid over the video data feed;
wherein the computer-generated content comprises augmented reality content;
wherein the augmented reality content corresponds to and augments the related events in reality occurring in real-time;
wherein the augmented reality content comprises an augmented reality overlay;
wherein the augmented reality overlay comprises augmented reality overlay data encoding video adapted to be combined with and overlaid over video data generated by the apparatus camera after, but nearly simultaneous to, generation of the augmented reality overlay data by the server; and
wherein a combination of the augmented reality overlay and the video data comprises an augmented-reality-overlaid video encoded by augmented-reality-overlaid video data adapted to be rendered and displayed on the display.

15. The apparatus of claim 13, the apparatus further comprising:
an apparatus wireless transceiver;
wherein the apparatus data transfer device comprises the apparatus wireless transceiver;
wherein the apparatus wireless transceiver is adapted to wirelessly transmit the positioning data from the apparatus to the server; and
wherein the apparatus wireless transceiver is adapted to wirelessly receive the computer-generated content at the apparatus transmitted from the server.

16. A system, the system adapted for use in displaying computer-generated content, the system comprising:
a server, the server adapted for communication with an apparatus, the apparatus adapted to be coupled to and in communication with a local software application and the server, wherein the server comprises:
server electronic circuitry and hardware including:
a server processor;
a server memory, the server memory coupled to the server processor;
a server data transfer module, the server data transfer module coupled to the server processor;
a server data transfer device, the server data transfer device coupled to the server processor;
server electronic software, the server software stored in the server electronic circuitry and hardware and adapted to enable, drive, and control the server electronic circuitry and hardware; and
a server power supply connection, the server power supply connection coupled to the server electronic circuitry and hardware and couplable to a server power supply;
wherein the server is adapted to receive positioning data from the apparatus;
wherein the server is adapted to generate the computer-generated content based on receiving the positioning data from the apparatus;
wherein the server is adapted to transmit the computer-generated content to the apparatus upon generation of the computer-generated content;
wherein the apparatus comprises:
apparatus electronic circuitry and hardware including:
an apparatus processor;
an apparatus camera, the apparatus camera coupled to the apparatus processor;
an apparatus display, the apparatus display coupled to the apparatus processor;
an apparatus memory, the apparatus memory coupled to the apparatus processor;
an apparatus positioning device, the apparatus positioning device coupled to the apparatus processor;
an apparatus data transfer module, the apparatus data transfer module coupled to the apparatus processor;
an apparatus data transfer device, the apparatus data transfer device coupled to the apparatus processor;
apparatus electronic software, the apparatus software including the local software application, and the apparatus electronic software being stored in the apparatus electronic circuitry and hardware and adapted to enable, drive, and control the apparatus electronic circuitry and hardware;
an apparatus power supply connection, the apparatus power supply connection coupled to the apparatus electronic circuitry and hardware and couplable to an apparatus power supply; and
an apparatus housing, the apparatus housing comprising an apparatus interior and an apparatus exterior housing, the apparatus interior containing the apparatus electronic circuitry and hardware, the apparatus software, and the apparatus power supply connection; and the apparatus exterior housing comprising an apparatus frame enclosing the apparatus optical lens assembly;
wherein the apparatus positioning device is adapted to generate positioning data indicative of at least one parameter of a group consisting of a position, a location, an orientation, a movement, and a point of view of the apparatus;
wherein the apparatus is adapted to transmit the positioning data to the server;
wherein the apparatus is adapted to receive the computer-generated content from the server;
wherein the apparatus is adapted to render and to display the computer-generated content on the apparatus display;
wherein the computer-generated content includes dynamic content changing over time and space in real-time as related events in reality occur;
wherein the dynamic content is selected from a content group consisting of augmented reality content and virtual reality content;
wherein the computer-generated content comprises computer-generated content data encoding video;
wherein the computer-generated content and computer-generated content data are adapted to be generated by the server based on the positioning data;
wherein the computer-generated content is customized to the apparatus based on the computer-generated content data being generated after, but nearly simultaneous to, generation of the positioning data;
wherein the computer-generated content is rendered and displayed on the apparatus display after, but nearly simultaneous to, generation of the computer-generated content by the server; and
wherein an occurrence of data generated, rendered, or displayed after, but nearly simultaneous to, generation of other data occurs within a latency not to exceed one second.

17. The system of claim 16, the system further comprising:
the apparatus.

18. The system of claim 17, the system further characterized:
wherein the apparatus camera is adapted to generate video data;
wherein the apparatus is adapted to combine the video data in a video data feed with the computer-generated content;
wherein the apparatus is adapted to overlay the computer-generated content over the video data feed;
wherein the apparatus is adapted to display on the apparatus display a combination of the computer-generated content overlaid over the video data feed;
wherein the computer-generated content comprises augmented reality content;
wherein the augmented reality content corresponds to and augments the related events in reality occurring in real-time;
wherein the augmented reality content comprises an augmented reality overlay;
wherein the augmented reality overlay comprises augmented reality overlay data encoding video adapted to be combined with and overlaid over video data generated by the apparatus camera after, but nearly simultaneous to, generation of the augmented reality overlay data by the server; and
wherein a combination of the augmented reality overlay and the video data comprises an augmented-reality-overlaid video encoded by augmented-reality-overlaid video data adapted to be rendered and displayed on the display.

19. The system of claim 16, the system further characterized:
wherein the apparatus further comprises:
an apparatus wireless transceiver;
wherein the apparatus data transfer device comprises the apparatus wireless transceiver;
wherein the apparatus wireless transceiver is adapted to wirelessly transmit the positioning data from the apparatus to the server;
wherein the apparatus wireless transceiver is adapted to wirelessly receive the computer-generated content at the apparatus transmitted from the server; and
wherein the server data transfer device is in communication with a network wireless transceiver in wireless communication with the apparatus wireless transceiver.

20. The system of claim 16, the system further comprising:
a console; and
an intermediate computing device,
wherein the console comprises the apparatus processor, the apparatus camera, the apparatus display, the apparatus memory, the apparatus positioning device, the apparatus data transfer module, the apparatus data transfer device, related aspects of the apparatus software, the apparatus housing, and the apparatus power supply connection;
wherein the intermediate computing device comprises another processor, another memory, another data transfer module, another data transfer device, other aspects of the apparatus software, another housing, and another power supply connection;
wherein the intermediate computing device may be referred to as an auxiliary processing unit;
wherein the auxiliary processing unit is electronically couplable to the console; and,
wherein the auxiliary processing unit is adapted to handle aspects of data transfer and data processing separately from the console in generating, transferring, and processing the computer-generated content;
wherein the intermediate computing device adapted to transmit the positioning data to the server;
wherein the intermediate computing device adapted to receive the computer-generated content from the server; and
wherein the intermediate computing device adapted to process the computer-generated content for displaying the computer-generated content on the apparatus display.
